(19) United States
(12) Patent Application Publication
(10) Pub. No.: US 2004/0143661 A1
(43) Pub. Date: Jul. 22, 2004

(54) Content history log collecting system

(76) Inventors: Akio Higashi, Takatsuki-shi (JP); Mitsuhiro Inoue, Osaka-shi (JP); Katsumi Tokuda, Ikeda-shi (JP); Hiroki Murakami, Suita-shi (JP); Masanori Nakanishi, Osaka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/754,512

(22) Filed: Jan. 12, 2004

(30) Foreign Application Priority Data
Jan. 14, 2003 (JP) 2003-006047

(51) Int. Cl. G06F 17/40; G06F 15/16

(52) U.S. Cl. 709/224; 702/187; 709/229

(57) ABSTRACT

The system of the present invention is a system comprising a server device which provides a license and a terminal device which controls content use based on the license provided from the server device, wherein the server device includes the first collecting unit operable to collect the first history logs concerning the content use sent from the terminal device, the second collecting unit operable to collect the second history logs concerning the content use sent from the terminal device separately from the collection by the first collection unit and the verifying unit operable to verify the first history logs collected by the first collection unit and the second history logs collected by the second collection unit, and the terminal device includes the first acquirement unit operable to acquire the first history logs concerning the content use and the second acquirement unit operable to acquire the second history logs concerning the content use and a history log sending unit operable to separately send the first history logs acquired in the first acquirement unit and the second history logs acquired in the second acquirement unit.

### BACKGROUND OF THE INVENTION

(1) Field of the Invention

The present invention relates to a system for distributing digital contents such as video and music and a license for digital contents from a server device via a communication network or broadcasting and enabling a user to use the digital contents in a terminal device, especially a system and a device that allows a terminal device to collect digital content history logs according to use control of digital contents based on a license and send the history logs to the server device and allow a server device to collect user's history logs of the digital contents.

(2) Description of the Related Art

A system called content distribution system is in the stage of practical use recently, the content distribution system makes it possible to distribute digital contents such as music, video, game and the like from a server device to a terminal device via a communication network such as the Internet or digital broadcasting and use the contents using the terminal device. In generally-used content distribution systems, copy right protection technique is used so as to protect a copy right of digital contents and prevent unpermitted use of contents by a malicious user or others. More specifically, copy right protection technique is technique for securely controlling content use such as the case where a user plays back a content or copies it to a storage medium using encryption/decryption technique or the like.

Those systems includes a system that makes it possible to acquire a content rating in a server device by acquiring history logs showing that its user used the content securely using the terminal device.

For example, in the patent literature 1 and the patent literature 2, a system for recording times and time of playing back contents or copying contents to a storage media and the like as history logs and periodically sending history logs to a specified server device is written as an example of a content history log collecting system.

In this way, in the conventional content history log collecting system, it is possible to send history logs such as content use times and time by a user to a server device.

[Patent Literature 1]

Japanese Laid-Open Patent application No. 2000-564425

[Patent Literature 2]

Japanese Laid-Open Patent application No. 2001-160003

However, in conventional content use history log systems, it is impossible to obtain various kinds of useful history logs by associating history logs collected in a plurality of methods with each other because it considers only history logs collected in a single way.

For example, in a streaming distribution, it is impossible to associate an overnight, which is obtained by grasping the receiving state of the streaming in the terminal side in real time from the transmitting side, with a secure history log, and thus it is impossible to realize immediacy and authenticity concurrently in a rating survey. Also, it is impossible to improve the authenticity of a nonsecure history log by adding a secure history log to a questionnaire in a web with a low authenticity, user's past record of using an EPG (Electronic Program Guide), the charging record and the like. Therefore, there is a problem that it is impossible to provide secure and useful information to a service provider and a user.

Also, in the case where history logs obtained using a nonsecure method includes an error because of a missing packet caused by a deluge of networks, a transmitting error, a manipulation by a user, a breakdown of the terminal device 102 or the like, a service provider and its user were not able to know about the error. Also, a service provider and its user have no reason to fully believe a history log.

There is a need to improve the authenticity of content history logs to a service provider and its user and further guarantee them the authenticity as a content distribution between a server device and a terminal device becomes popular.

### SUMMARY OF THE INVENTION

The object of the present invention is to improve the authenticity of the content history log collected in the system for distributing contents between a server device and a terminal device to a service provider and its user and further providing a content distributing system that guarantees the authenticity.

The system for achieving the above-mentioned object comprises a server device that provides a license and a terminal device that controls content use based on a license provided from the server device, wherein the server device includes: a first collecting unit operable to collect first history logs concerning the content use sent from the terminal device; a second collecting unit operable to collect the second history logs concerning the content use sent from the terminal device separately from the collection by the first collection unit; and a verifying unit operable to verify the first history logs collected by the first collecting unit and the second history logs collected by the second collecting unit; and the terminal device includes: a first acquirement unit operable to acquire the first history logs concerning the content use; a second acquirement unit operable to acquire the second history logs concerning the content use; and a history log sending unit operable to separately send the first history logs acquired by the first acquirement unit and the second history logs acquired by the second acquirement unit.

As a server device collects the first and the second history logs separately and verifies the collected first and second history logs, this construction has an effect of improving the authenticity of the first and the second history logs when they are verified as authentic and further guarantees their authenticity. Also, it has an effect of detecting that they do not have enough authenticity when they are verified as inauthentic.

For example, there is no sufficient reason for authenticating history logs conventionally when the first and the second collection units collects the first and the second history logs nonsecurely. The above-mentioned construction can provide enough reason for relying on the first and the second history logs when they are verified as authentic, while it can provide a reason for not authenticating when they are verified as inauthentic.

Here, the first acquirement unit securely acquires the first history logs, and the history log sending unit securely sends the first history logs.

Here, the second acquirement unit nonsecurely acquires the second history logs, and the history log sending unit nonsecurely acquires the second history logs.

The construction can guarantee the authenticity of the second history logs collected nonsecurely when they are verified as authentic by the verification unit, and can detect that the second history logs do not have authenticity when they are verified as inauthentic by the verification unit.

Here, the first and the second history logs include at least one of a terminal ID, a content ID, a user ID, a description of user operation concerning the content use and user operation time respectively, and the verifying unit verifies that the first history logs are substantially the same as the second history logs by comparing them with each other.

With this construction, the verification unit judges whether, for example, the two pieces of user operation time is substantially the same or not by comparing them with each other so as to judge whether they match each other with a permissible difference. Further, the verification unit compares the two terminal IDs, the two content IDs, the two user IDs and the like respectively to each other so as to judge whether the pair of same kind IDs fully match each other or not and judges whether they are the same or not. In this way, the verification unit can verify whether they are substantially the same or not by flexibly comparing them with each other and judging them as the same or not. The verification unit can verify that they are substantially the same or not based on the comparison result of the first history log and the second history log.

Here, the server device further includes a storage unit operable to store one of (a) at least one of the first history logs and the second history logs and (b) history logs generated based on (a) in a history log database unit according to the verification result by the verifying unit.

With this construction, for example, the storage unit stores one of (a) at least one of the first history logs and the second history logs and (b) history logs generated based on (a) in the history log database when they are judged as substantially the same. In this way, it is possible to store only history logs with a high authenticity. Also, for example, the storage unit stores a history log in a part differently selected depending on the case, that is, a case where they are judged as substantially the same or a case where they are judged as not substantially the same. In this way, history logs with a low authenticity can be utilized for a cause investigation and the like.

Here, the verifying unit generates comparison information showing the comparison result when the comparison result is not substantially the same.

With this construction, for example, the comparison information shows “match” or “unmatch” for every item in the first and the second history logs and the unmatch item can be utilized for a cause investigation and the like when they are judged as not substantially the same.

Here, the server device further includes: a database unit operable to store the collection conditions concerning the history logs to be collected in the terminal device; a generation unit operable to dynamically generate indication information indicating a request that the terminal device collect the history logs according to the collection condition stored in the database unit; and an indication information sending unit operable to send the generated indication information to the terminal device; and the first acquirement unit acquires the first history logs according to the indication information sent from the server device.

Here, the collection condition relates to a combination of two or more data selected from content use date and time, a use part of whole played-back part of a content, a description of user operation for using a content, a user profile, user's terminal device ID, user's use status, a content use status and a content service providing status.

With this construction, the server device sends indication information dynamically generated according to a collection condition to the terminal device and the terminal device collects history logs according to the indication information. As a result, there is an effect that history logs can be collected flexibly according to the needs of a service provider and a various kinds of service forms.

Here, the server device further includes: a use condition database unit operable to store content use conditions for each user of the terminal device; and a license issuing unit operable to issue a license for permitting a user to use a content to the terminal device according to the use condition of a user stored in the use condition database unit; and the terminal device further includes: a content use unit operable to use a content according to the issued license; and the indication information sending unit operable to send the license with the indication information.

With this construction, the server device can dynamically generate indication information relating to the collection of history logs when issuing a license according to the use condition or solely at any time.

Also, a server device, a terminal device and a history log collection method and a program which are capable of achieving the above-mentioned object have the same construction, action and effect as the above.

Further Information about Technical Background to this Application

filed, is incorporated herein by reference.

Japan Patent application No. 2003-006047 filed Jan. 14, 2003.

### BRIEF DESCRIPTION OF THE DRAWINGS

These and other subjects, advantages and features of the invention will become apparent from the following description thereof taken in conjunction with the accompanying drawings that illustrate a specific embodiment of the invention. In the Drawings:

FIG. 1 is a diagram showing the outline structure of the whole content history log collecting system 1 concerning the embodiment of the present invention.

FIG. 2 is a functional block diagram showing the construction of the right management server 101b concerning the first embodiment of the present invention.

FIG. 3 is a diagram showing the table construction of the user information DB 201 concerning the first embodiment of the present invention.

FIG. 4 is a diagram showing the table construction of the content key DB 202 concerning the first embodiment of the present invention.

FIG. 5 is a diagram showing the table construction of the use condition DB 203 concerning the first embodiment of the present invention.

FIG. 6 is a diagram showing the table construction of the history log collection condition DB 204 concerning the first embodiment of the present invention.

FIG. 7 is a diagram showing the table construction of the first history log DB 205 concerning the first embodiment of the present invention.

FIG. 8 is a diagram showing the construction of the LT 800 concerning the first embodiment of the present invention.

FIG. 9 is a diagram showing the construction of the history log collection indication tag block 804 concerning the first embodiment of the present invention.

FIG. 10 is a functional block diagram showing the construction of the content distribution server 101c concerning the first embodiment of the present invention.

FIG. 11 is a diagram showing the construction of the receiver report (RR) 1100 concerning the first embodiment of the present invention.

FIG. 12 is a diagram showing the table construction of the second history log DB 1012 concerning the first embodiment of the present invention.

FIG. 13 is a functional block diagram showing the construction of the history log management server 101e concerning the first embodiment of the present invention.

FIG. 14 is a diagram showing the table construction of the history log DB 1301 concerning the first embodiment of the present invention.

FIG. 15 is a diagram showing the construction of the terminal device 102 concerning the first embodiment of the present invention.

FIG. 16 is a diagram showing the construction of the ELI 1600 concerning the first embodiment of the present invention.

FIG. 17 is a diagram showing the construction of the LT 800 including history logs concerning the embodiment of the present invention.

FIG. 18 is a diagram showing the construction of the history log tag block 1705 concerning the embodiment of the present invention.

FIG. 19 is a flow chart showing the obtainment processing of the LT 800 from the right management server 101b in the terminal device 102 concerning the embodiment of the present invention.

FIG. 20 is a flow chart showing the LT issuability judgment processing in the right management server 101b concerning the embodiment of the present invention.

FIG. 21 is a flow chart showing the history log collection indication generation processing in the right management server 101b concerning the second embodiment of the present invention.

FIG. 22 is a flow chart showing the content use processing and the history log record processing in the terminal device 102 concerning the second embodiment of the present invention.

FIG. 23 is a flow chart showing the content use processing in the terminal device 102 concerning the second embodiment of the present invention.

FIG. 24 is a flow chart showing the stream transmitting processing in the content distribution server 101c concerning the embodiment of the present invention.

FIG. 25 is a flow chart showing the history log sending processing to the right management server 101b in the terminal device concerning the embodiment of the present invention.

FIG. 26 is a flow chart showing the verification processing of the second history logs using the first history logs in the history log analysis unit 1313 concerning the embodiment of the present invention.

FIG. 27 is a flow chart showing the comparison processing of the average packet receiving rate and a threshold in the history log analysis unit 1313 concerning the embodiment of the present invention.

FIG. 28 is a diagram showing the case where the average packet receiving rate concerning the embodiment of the present invention is not less than a threshold.

FIG. 29 is a diagram showing the case where the average packet receiving rate concerning the embodiment of the present invention is under a threshold.

FIG. 30 is a flow chart showing the obtainment processing of the history log list from the history log management server 101e in the terminal device 102 concerning the embodiment of the present invention.

FIG. 31 is a flow chart showing the questionnaire sending processing to the distribution center 101 in the terminal device 102 concerning the embodiment of the present invention.

FIG. 32 is a flow chart showing the sending processing of the first history log and the EPG history log to the distribution center 101 in the terminal device 102 concerning the embodiment of the present invention.

FIG. 33 is a diagram showing the construction of the EPG data 3300 concerning the embodiment of the present invention.

### DESCRIPTION OF THE PREFERRED EMBODIMENT(S)

The first embodiment of the present invention will be explained in detail below with reference to figures.

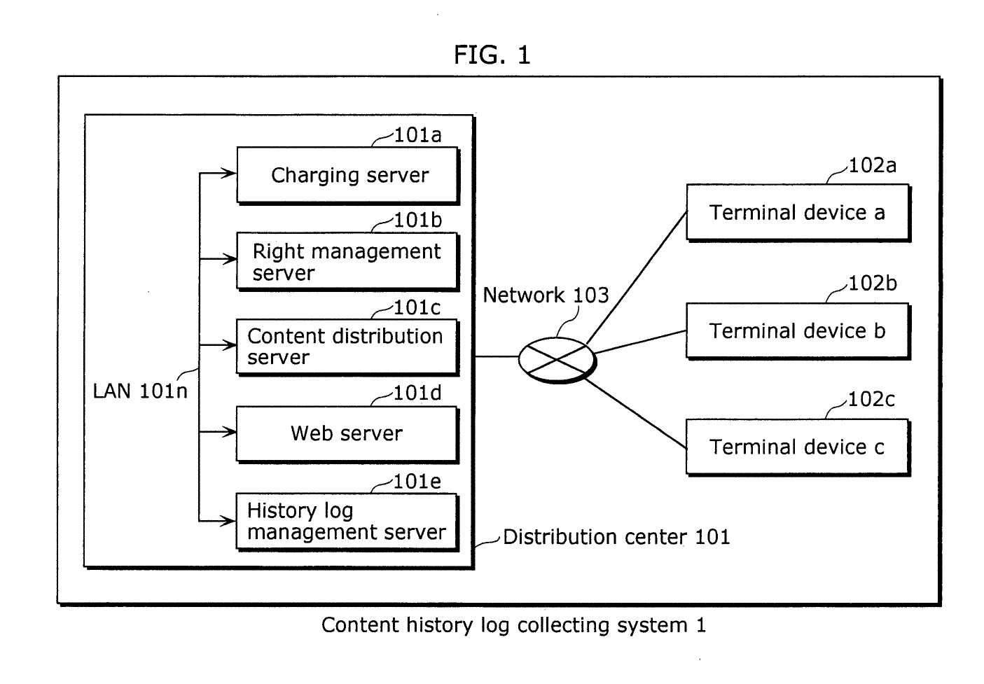

FIG. 1 is a diagram showing the outline structure of the whole content history log collecting system 1 concerning the first embodiment of the present invention.

This content history log collecting system 1 is a system for allowing a user to use a content to be distributed from a distribution center (that is, a service provider) via a network, a storage media or the like, and it comprises a distribution center 101 for distributing a content and the like, terminal devices 102a to 102c for using the content, a network 103 for connecting them with each other.

The distribution center 101 comprises a charging server 101a for charging a user, a right management server 101b for managing a content use right (use condition) owned by a user, generating a content license and distributing a content to the terminal devices 102a to 102c, a content distribution server 101c for distributing a content, a web server 101d for sending web pages for providing a various kind of services to the terminal devices 102a to 102c via the network 103 and the history log management server 101e for managing history logs collected from the terminal devices 102a to 102c.

The charging server 101a is a server device for charging a user on-line when purchasing content use conditions and the like via the Internet or the like. More specifically, the charging server 101a charges a fee to a credit card or accepts payments by credit card or registers user's bank account number in advance in the charging server 101a and charges a fee to the bank account or accepts payments by bank transfer based on the purchase history and the like uploaded from the terminal devices 102a to 102c via the network 103.

The right management server 101b is a server device for managing a content use condition owned by a user and giving the user the license for the content. More specifically, the right management server 101b manages the content use conditions owned by each user or each of terminal devices 102a to 102c and distributes these licenses to terminal devices 102a to 102c via the network 103. Also, in a push-style distribution form such as digital broadcasting, broadband broadcasting or the like, it is possible to use a content by distributing a temporally invalidated license together with the content and validating licenses by performing charging processing in the terminal devices 102a to 102c.

Note that a license is data called a license ticket (written as LT below) and comprises a decryption key (a content key) for decrypting an encrypted content, use conditions such as a validated period for using a content, content use times. When sending and receiving data such as an LT between the distribution center 101 and terminal devices 102a to 102c via the network 103, a secure authenticated channel (written as SAC) is established so as to ensure security and then the data is received and sent via the SAC. The data construction of an LT will be explained in detail later with reference to a figure.

Also, a generally-used encryption algorithm for encrypting a content is a common key encryption algorithm such as the advanced encryption standard (AES), the data encryption standard (DES) and the like.

The content distribution server 101c is a server device for distributing a content to the terminal devices 102a to 102c via the network 103, and it is realized in a form of workstation or the like. More specifically, the content distribution server 101c is digitally compressed using a compression method such as the moving picture experts group (MPEG-2), MPEG-4 or the like and distributes the contents encrypted using AES, Triple DES or the like as necessary in a stream.

Especially, when distributing a content in a stream in a network in which the internet protocol (IP) such as the Internet is used, the realtime transfer protocol (RTP) and the real time control protocol (RTCP) are used, both of which are standardized as the request for comments (RFC) by the internet engineering task force (IETF).

The RTP divides a content into packets with a variable length called the RTP packet and transmits them, and information on a reassignment of the RTP packet, a sequence number for detecting a loss of the RTP packet, a time stamp used for synchronizing the video with sound in a stream can be set in the header of the RTP packet. The RTP is generally used considering the UDP/IP as the lower protocol.

The RTCP is a protocol for controlling the RTP, used together with the RTP, and can feedback, to the transmission side, a packet loss or a delay jitter which can be detected when receiving the RTP packet. The transmission side performs streaming band width control or the like using this feedback information.

In other words, in a streaming distribution, the content distribution server 101c divides a content requested from the terminal devices 102a to 102c, adds an RTP header to it, generates RTP packets and sends them to the terminal devices 102a to 102c in sequence. The terminal devices 102a to 102c deconstruct the received RTP packet, decode video and sound referring to the information inside the RTP header and output it on a monitor or the like. At that time, it detects a packet loss, a delay jitter or the like which are obtained from the RTP header and sends it to the content distribution server 101c using an RTCP.

Also, the content distribution server 101c can be a system for distributing a download type content, in this case, it can be a server device that provides a download content using a protocol such as the File Transfer Protocol (FTP), the HyperText Transfer Protocol (HTTP) and the like. Also, in the case of digital broadcasting, it can be a transmitting device that provides a stream type content in the MPEG-2 Transport Stream (TS) or a transmitting device that provides a storage type content based on a data carousel transmitting method shown in the Association of Radio Industries and Businesses (ARIB) STD-B24 or the like.

The web server 101d provides a user with a screen display for purchasing a content or the like to access various kinds of services from the terminal devices 102a to 102c. More specially, the web server 101d provides a web page written in script language such as the HyperText Markup Language (HTML) or the Extensible Markup Language (XML) using a protocol such as HTTP and the like via the Internet or provides a web page written in the Broadcasting Markup Language (BML) in digital broadcasting.

The history log management server 101e is a server device for managing various kinds of history logs recorded in the terminal devices 102a to 102c. More specifically, the history log management server 101e receives various kinds of history logs recorded based on a record of content use, a result of charging processing, a request from a user, a record of content sending which are sent from the terminal devices 102a to 102c from the charging server 101a, a right management server 101b, a content distribution server 101c and a web server 101d and manages them.

The LAN 101n is a network for connecting a charging server 101a, a right management server 101b, a content distribution server 10c, a web server 101d and a history log management server 101e with each other in the distribution center 101. For example, it can be realized using a wired network such as the IEEE 802.3 or the like or a wireless network such as the IEEE 802.11b or the like.

The network 103 is a network that alternately connects the distribution center 101 with terminal devices 102a to 102c. For example, the network 103 is a network of a communication network such as the Internet, digital broadcasting or a multiplexed network of those listed earlier.

The terminal devices 102a to 102c have a function for connecting with the network 103 and are terminal devices for enabling a user to use contents on a monitor display screen or write contents on a storage medium. More specifically, the terminal devices 102a to 102c are any of a set top box (STB) for receiving digital broadcasting, a digital TV, a digital versatile disc (DVD) recorder, a hard disk drive (HDD) recorder, a content displaying device such as a personal computer (PC), a recorder or a multiplexed device of those listed earlier.

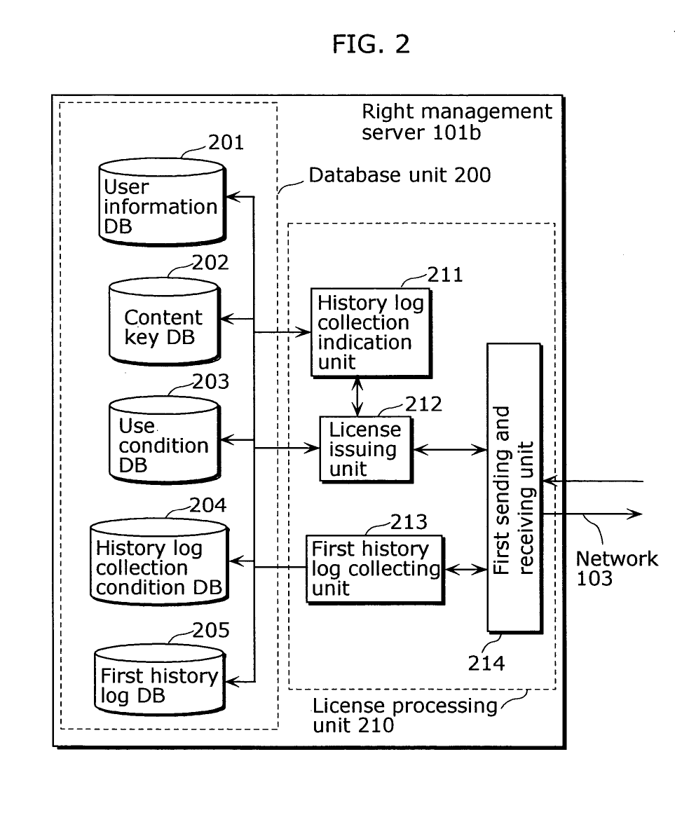

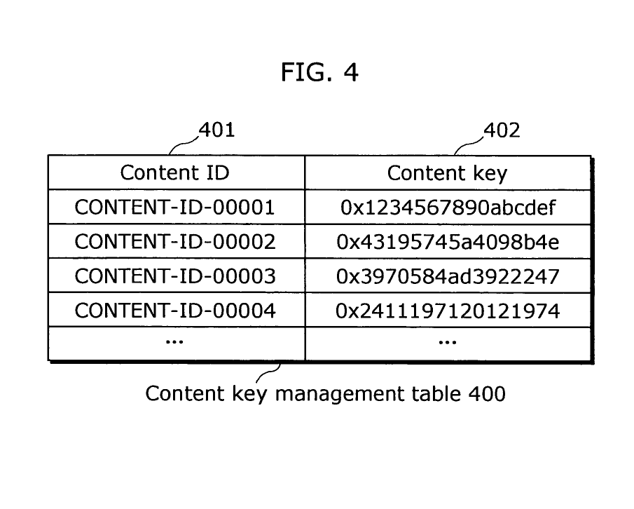

In this content history log collecting system 1, a content or a license is distributed via the network 103, a content is used in the terminal devices 102a to 102c, content history logs are recorded in a plurality of methods, the history logs are sent from the terminal devices 102a to 102c to the distribution center 101, and the history logs are associated with each other in the distribution center 101. The above processing will be explained in detail with reference to FIG. 2 to FIG. 26. As to the terminal devices 102a to 102c below, the terminal device 102a is made to be the representative and explained as the terminal device 102. Also, the following explanation is made defining the obtained secure history log as the first history log and the nonsecure history log obtained in a way different from the way in the case of the first history log as the second history log in the terminal device 102.

Also, here is an example case where the right management server 101b of the distribution center 101 instructs the terminal device 102 to collect the first history log using an LT and collects the first history log from the terminal device 102 using the LT, the content distribution server 101c distributes a streaming content from the content distribution server 101c to the terminal device 102, a terminal device 102 measures the receiving status of a stream as the second history log and a terminal device 102 feedbacks the second history log to the content distribution server 101c in the terminal device 102.

FIG. 2 is a functional block diagram showing the detailed construction of the right management server 101b in the distribution center 101 shown in FIG. 1.

The right management server 101b comprises, roughly in part, a database unit 200 that is realized by a data file or the like stored in an HDD or the like and a license processing unit 210 that is realized by a hardware such as an LSI or a program or the like that is executed using a CPU, RAM, ROM or the like. The database unit 200 comprises a user information DB 201, a content key DB 202, a use condition DB 203, a history log collection condition DB 204 and the first history log DB 205, and the license processing unit 210 comprises a history log collection indication unit 211, a license issuing unit 212, the first history log collection unit 213 and the first sending and receiving unit 214.

First, each component of the database 200 will be explained in detail.

The user information DB 201 is a database that has a user information management table for managing the information on a user and is used for associating the terminal device 102 for accessing the right management server 101b with a user who owns a content use condition that is managed in the use condition DB 203.

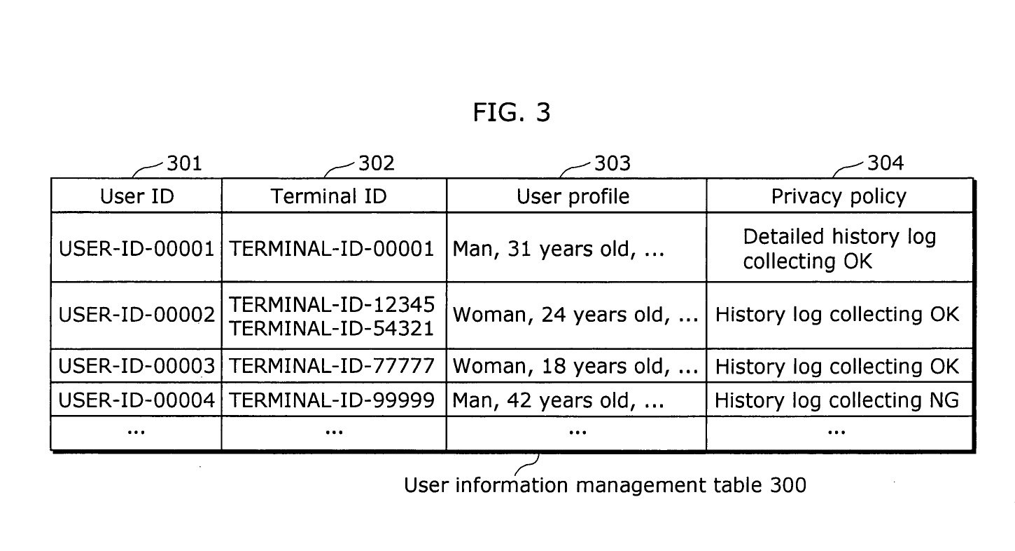

More specifically, the user information DB 201 has the user information management table 300 shown in FIG. 3 and manages a user ID 301 for identifying a user in the content history log collecting system 1, a terminal ID 302 for identifying the terminal device 102 in the content history log collecting system 1, a user profile 303 for showing the detailed information on a user and a privacy policy 304 for showing each user's policy on history log collection.

Here, the user profile 303 shows registered user information such as user's name, age, sex, address, favorite programs, hobbies and so on and can be used for choosing users whose history logs are to be collected and can also be used as a judgmental standard for analyzing user's content use tendency based on the relationship between user's favorite program and a program collected as history logs.

Also, the privacy policy 304 is information showing whether a user permits a service provider to use part or all of his or her content history logs or not and is for realizing history logs according to each user's intention on privacy.

For example, in FIG. 3, it is shown that a user whose user ID 301 is “USER-ID-00001” owns a terminal device 102 whose terminal ID 302 is “TERMINAL-ID-00001”. Also, a user profile 303 shows that a user whose user ID is “USER-ID-00001” is a man of 31 years old, and that he permits his service provider to collect his content history logs in the terminal device 102 in detail because his privacy policy 304 reads “Detailed history log collecting OK”. Here, detailed history logs mean detailed user operation descriptions and the like concerning the content used by the user in the terminal device 102, these history logs are information concerning the played back part of the content, special playback such as forwarding and rewinding and the like as to the first history log collection.

Also, a user whose user ID 301 is “USER-ID-00002” owns two terminal devices 102 whose terminal IDs 302 are “TERMINAL-ID-12345” and “TERMINAL-ID-54321” respectively, which shows that she can access the right management server 101b from any of terminal devices 102.

Also, the privacy policy 304 of a user whose user ID is USER-ID-00002” reads “History log collecting OK”, which shows that she permits her service provider to collect the first history logs at transaction-level such as content playback or copy times in the terminal 102 although she does not permit the service provider to collect the first content history logs in detail in the terminal device 102 like a user whose user ID is “USER-ID-00001” does. In contrast, the privacy policy 304 of a user whose user ID is USER-ID-00004” reads “History log collecting NG”, which shows that he does not permit his service provider to collect content history logs.

Note that data is registered to the user information DB 201 when a service provider registers a user as a member to provide services. A user can be perform this member registration processing on-line between the distribution center 101 and the terminal device 102 using a member registration display screen which is provided by a web server 101d via the network 103 or off-line using a postcard for member registration or the like. In the member registration processing, a service provider assigns a user a user ID 301 first. After that, as a terminal ID 302 of a user terminal device 102 is sent to the service provider on-line or off-line, the user ID 301 is associated with the terminal device ID 302 and these IDs are registered in the user information management table 300 of the user information DB 201. As a result from performing the member registration processing like shown above, a user information DB 201 is established.

The content key DB 202 is a database unit operable to manage content keys for decoding encrypted contents, is used for acquiring a content key corresponding to a content ID included in an LT acquirement request when generating an LT as a response to a license acquirement request (an LT acquirement request) from the terminal device 102.

More specifically, the content key DB 202 owns a content key management table 400 comprising a content ID 401 for identifying a content in the content history log collecting system 1 and a content key 402 corresponding to content ID 401.

For example, the content key needed for decrypting the encrypted content whose content ID 401 is “CONTENT-ID-00001” is the one whose content key ID 402 is “0x1234567890abcdef”.

The use condition DB 203 is a database unit operable to manage content use conditions for each user and is used for generating an LT when it judges that the LT acquirement request from the terminal device 102 satisfies user's use condition.

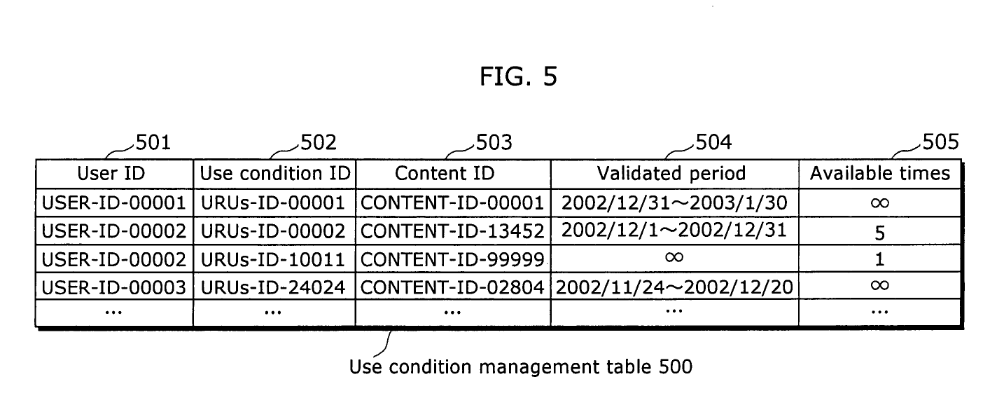

More specifically, the use condition DB 203 identifies a user in the content history log collecting system 1 as shown in FIG. 5 and owns a use condition management table 500 comprising a user ID 501 showing the owner of the use condition, a use condition ID 502 for identifying a use condition owned by a user shown by the user ID 501, a content ID 503 for identifying a content to be made available by a use condition in the content history log collecting system 1, a validated period 504 showing starting and finishing date and time for using the content shown by the content ID 503 and an available times 505 showing content available times shown by the content ID 503.

For example, a user whose user ID 501 is “USER-ID-00001” holds a use condition of “URUs-ID-00001” as a use condition ID 502. The use condition “URUs-ID-00001” is a content of “CONTENT-ID-00001” shown by the content ID 503 as a content to be made available, the validated period 504 is “2002/12/31 to 2003/1/30” and the available times 505 is infinite, that is, it can be used unlimitedly.

Also, a user whose user ID 501 is “USER-ID-00002” owns two use conditions of “URUs-ID-00002” and “URUs-ID-10011” as the use condition ID 502. The use condition “URUs-ID-00002” out of these two is a use condition corresponding to a content whose content ID 503 is “CONTENT-ID-13452”, the validated period 504 is “2002/12/1 to 2002/12/31”, the available times 505 is “5 times”, which shows that the content is available up to 5 times during the validated period. Also, the use condition “URUs-ID-10011” is a content use condition of “CONTENT-ID-99999” as the content ID 503, the validated period 504 is infinite but the content available times is only “1 time” as shown by the available times 505.

The history log collection condition DB 204 is a database operable to manage conditions for indicating the collection of the first history log to the terminal device 102, manages data such as conditions concerning which users' first history logs should be collected, timing for recording the first history logs in the terminal device 102, timing for sending the first history logs from the terminal device 102 to the right management server 101b, descriptions of the first history logs to be recorded and the like specific for each content and is used when instructing the terminal 102 to collect the first history log.

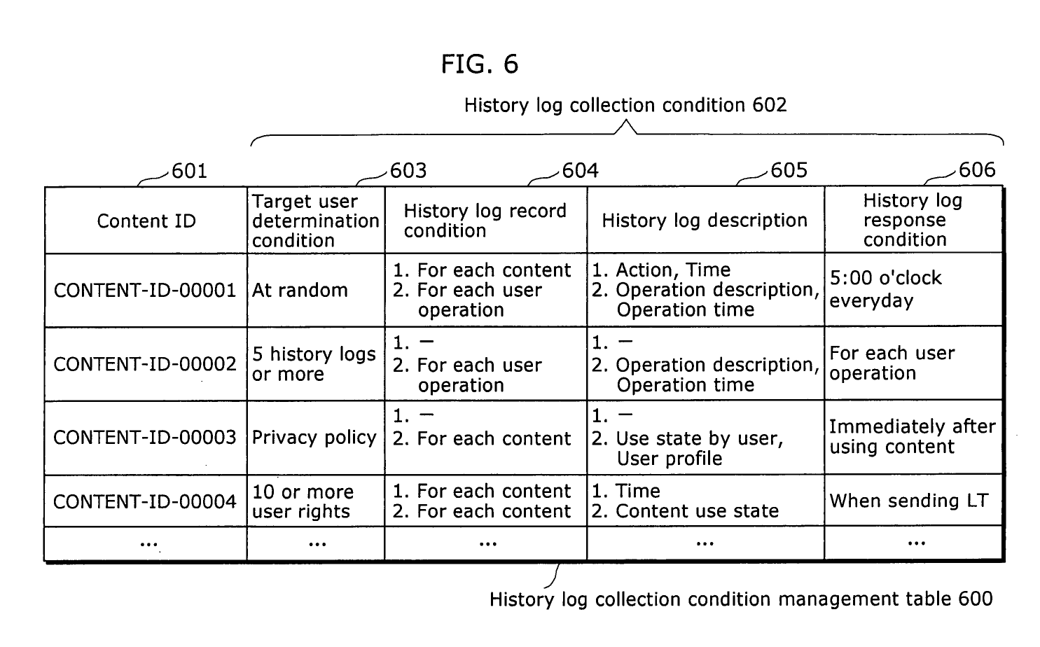

More specifically, the history log collection condition DB 204 has a history log collection condition management table 600 comprising a content ID 601 for identifying a content in the content history log collecting system 1 and a history log collection condition 602 showing conditions for determining users whose first history logs are to be collected and conditions on timings for collecting the first history logs and descriptions of the first history logs as shown in FIG. 6. The history log collection condition 602 includes a target user determination condition 603 showing conditions for determining users whose first history logs are to be collected, a history log record condition 604 showing conditions for recording the first history logs, a history log description 605 showing articles (descriptions) of the first history logs to be recorded and a history log response condition 606 showing conditions for sending the recorded first history logs from the terminal device 102 to the right management server 101b. Note that it is possible to collect second history logs by including a collection indication concerning the second history logs and making the terminal device 102 interpret the collection indication.

For example, as to the content whose content ID 601 is “CONTENT-ID-00001”, users whose first history logs are to be collected or terminal devices 102 are determined “at random” as shown by the target user determination condition 603. Also, the settings of the history log record condition 604 are “1. for each content” and “2. for each user operation”. This means “1. for each content” is a history log record condition at a transaction level and “2. for each user operation” is a detailed history log record condition on content use by the user. The history log record condition 604 indicate a request that the terminal device acquire the first history logs based on the above “1. for each content” and/or “2. for each user operation”.

Likewise, as the settings of the history log description 605 are “1. action, time” and “2. operation description, operation time”, “action” and “time” when the action is made are recorded as the first history logs at a transaction level, and detailed first user “operation descriptions” such as playback, forwarding and the like and “operation time” are recorded as the detailed first history logs. Further, the setting of the history log response condition 606 is “5:00 o'clock everyday”, which indicates that the registered first history logs are sent to the right management server 101b at 5:00 o'clock everyday.

As mentioned up to this point, the setting of the history log collection condition 602 of the content “CONTENT-ID-00001” are as follows: target users whose first history logs are to be collected are determined “at random” from the user information DB 201, the determined users indicate a request that the content use control unit 243 records “action” and “time” when the action is made “for each content”, the determined users indicate a request that the content use unit 251 record user's “operation descriptions” and the “operation time” “for each user operation” as the detailed first history logs and the recorded first history logs are sent to the right management server 101b at “5:00 o'clock everyday”.

Here, a conceivable method for determining users whose first history logs are to be collected at random is, for example, a method of generating random numbers using random numbers or the like and choosing users corresponding to user IDs 301 (such as 5-digit numbers following “USER-ID-”) in the user information management table 300 of the user information DB 201 corresponding to these random numbers.

Also, as the target user determination condition 603 of the content whose content ID 601 is “CONTENT-ID-00002” reads “5 history logs or more”, users whose first history logs are to be collected are determined on condition that the users have 5 or more history logs in the past when referring to the first history log DB 205 at the time of issuing an LT. Also, as shown by the history log record condition 604 of the “CONTENT-ID-00002” which reads “1.- ” “2. for each user”, the collection condition is an example indicating a request that the first history logs at a transaction level should not be acquired and that the first history logs for each user operation should be recorded as the detailed history logs, in other words, each time a user performs an operation such as playback, stop, pause, forwarding and so on. Also, as shown by the history log response condition 606 of the “CONTENT-ID-00002” which reads “for each user operation”, the first history logs are sent from the terminal device 102 to the right management server 101b when one or plural number of user operations are performed.

Further, in the case of a content whose content ID 601 is “CONTENT-ID-00003”, as its target user determination condition 603 reads “privacy policy”, judgment on whether the user makes a target user whose first history logs are to be collected or not is made according to the user privacy policy by referring to the user information DB 201. The history log description 605 of “CONTENT-ID-00003” indicates that “use state by user” and “user profile” should be collected.

“Use state by user” shows how the user uses the content in the terminal device 102, to put it more specifically, user's way of viewing the content such as viewing the content real time, viewing the content recorded by manual reservation recording, viewing the content recorded by automatic reservation recording and the like. Also, the user profile is information on the user such as user's age, sex, hobbies and the like set by the user in the terminal device 102.

Note that the history log response condition 606 of the content whose content ID is “CONTENT-ID-00003” reads “immediately after using content” and thus it is an example indicating a request that the first history logs should be sent from the terminal device 102 to the right management server 101b when finishing using the content.

Also, in the case of a content whose content ID is “CONTENT-ID-00004”, its target user determination condition 603 reads “10 or more user rights” indicating that only history logs of users who have 10 or more records of use conditions should be collected in the use condition DB 203. Also, as the history log description 605 reads “1. time” “2. content use state” indicating a request that the terminal device 102 records “time” when the action is performed as a first history log at a transaction level and the terminal device 102 record “content use state” as a detailed first history log.

Here, content use state shows mainly content quality such as content resolution, sound channel (such as 2ch playback or 5.1ch playback) and the like. Also, the history log response condition 606 reads “when sending LT” indicating that the first history logs should be collected when sending one or plural numbers of LTs.

In this way, a plurality of conditions (the collection conditions of the first history logs at a transaction level and the collection conditions of the detailed first history log) can be set as the history log collection condition 602 of a content ID 601 as shown in FIG. 6.

The first history log DB 205 is a database operable to store the first history logs collected from the terminal device 102 via the network 103.

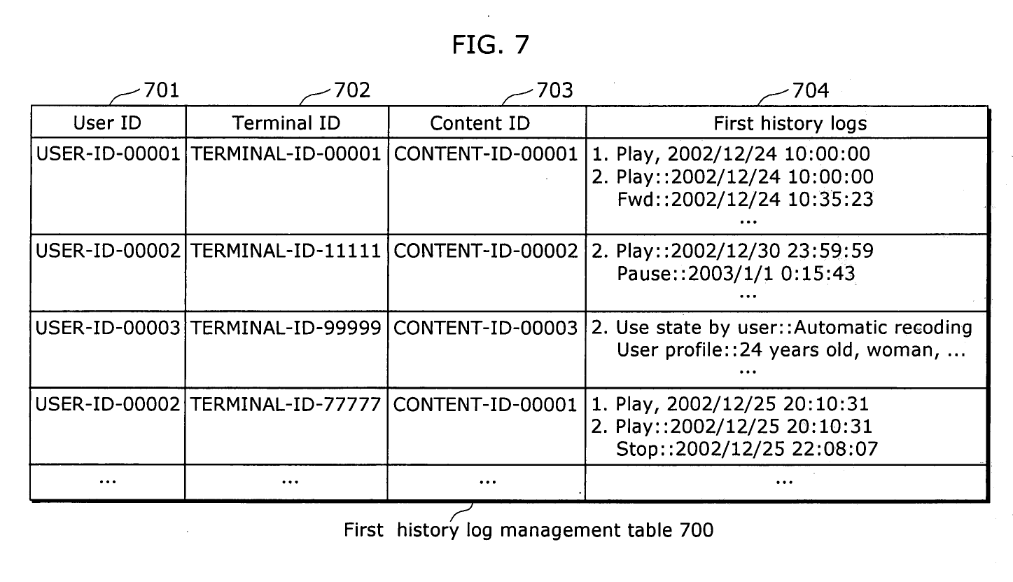

More specifically, the first history log DB 205 has the first history log management table 700 comprising a user ID 701 for identifying a user who used the content and whose first history logs were sent, a terminal ID 702 for identifying the terminal device 102 that recorded the first history logs, a-content ID 703 for identifying the content used by the user and the first history log 704 showing the descriptions of the first history logs collected from the terminal device 102 as shown in FIG. 7.

For example, the terminal ID 702 and the content ID 703 of a user whose user ID 701 is “USER-ID-00001” shows that the content of “CONTENT-ID-00001” was used in the terminal device 102 of “TERMINAL-ID-00001”, the first history log 704 shows following examples: “1. Play, 2002/12/24 10:00:00” showing the action and the time when the action is conducted, “2. Play::2002/12/24 10:00:00” showing detailed user operation descriptions and the time when the operation is performed, “Fwd::2002/12/24 10:35:23” and the like.

Likewise, as to the first history logs of a user whose user ID 701 is “USER-ID-00002”, the content of “CONTENT-ID-00002” is used in the terminal of “TERMINAL-ID-11111”, the detailed first history log acquired in the terminal device 102 is recorded as “Play::2002/12/30 23:59:59” as a detailed first history log and the following user operation description and time is recorded as “Pause::2003/1/1 0:15:43”. Further, as the first history logs of a user whose user ID 701 is “USER-ID-00003”, information indicating that “automatic recording is performed as the user use state, that the user is a woman of 24 years old as the user profile and the like are recorded.

Up to this point, the construction of the database unit 200 has been explained in detail.

Next, the construction of the license processing unit 210 will be explained in detail.

The history log collection indication unit 211 generates indication information for indicating the first history log collection to the terminal device 102.

More specifically, the history log collection indication unit 211 generates indication information for the first history log collection using a user information DB 201, a use condition DB 203, a history log collection condition DB 204, the first history log DB 205 and the like as necessary when receiving an LT issuing request from a user and sends the indication information to a license issuing unit 212 so as to make it an LT.

The license issuing unit 212 generates an LT in response to the LT issuing request from the terminal device 102.

More specifically, the license issuing unit 212 uses the user information DB 201, the content key DB 202 and the use condition DB 203 in response to the LT issuing request from the terminal device 102 and performs processing for generating an LT on condition that the LT issuing request satisfies the user use condition or not. Also, the license issuing unit 212 receives indication information for the first history log collection from the history log collection indication unit 211 so as to indicate that users' first history logs of contents should be collected from the right management server 101b to the terminal device 102 and sets the indication information as the LT.

The first history log receiving unit 213 receives the first history logs to be collected from the terminal device 102 and writes the received first history logs in the first history log DB 205.

More specifically, when the first sending and receiving unit 214 receives the LT sent from the terminal device 102, the first history log collecting unit 213 acquires the first history logs included in the LT and registers the history logs in the history log management table 700 in the first history log DB 205. Also, the history log receiving unit 213 processes the returned LT 800 as necessary and reflects the results in the user information DB 201, the use condition DB 203, the history log collection condition DB 204 or the like.

The first sending and receiving unit 214 communicates with the terminal device 102 via the network 103.

Up to this point, detailed construction of the right management server 101b has been explained.

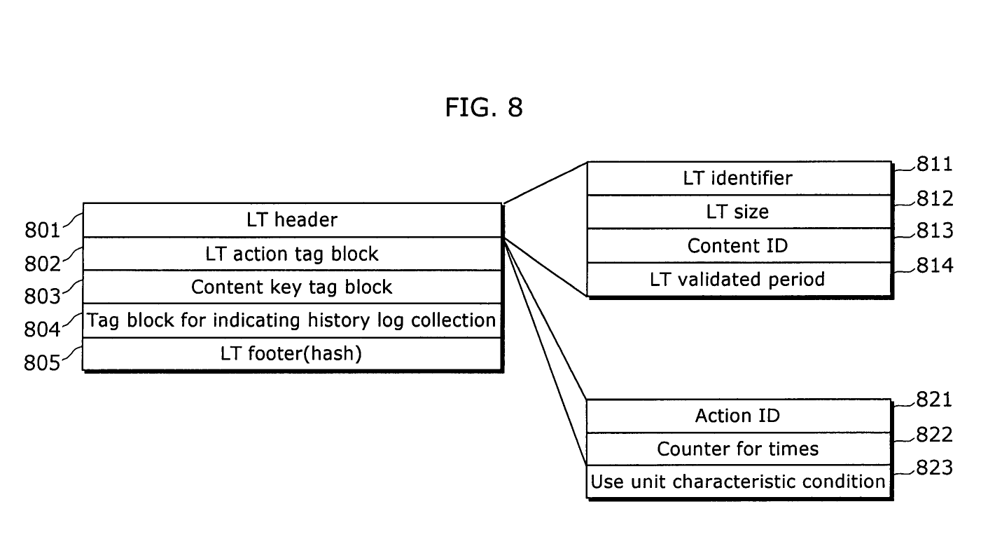

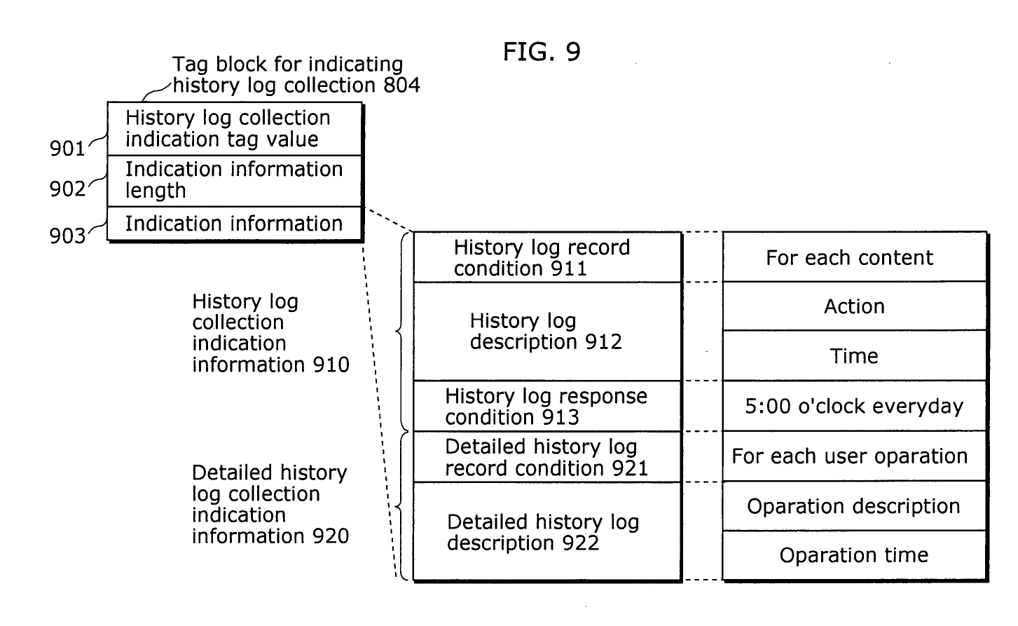

Here, constructions of the indication information for collecting LTs to be issued by the license issuing unit 212 and the first history logs to be generated by the history log collection indication unit 211 will be explained in detail with reference to FIGS. 8 and 9.

FIG. 8 is a diagram showing an example of an LT construction. The LT 800 shown in FIG. 8 comprises a content ID of a content to be made available by the LT 800, an LT header 801 including the validated period of the LT 800 and the like, an LT action tag block 802 showing use conditions such as available times of playing back contents and copying contents in a storage medium, a content key tag block 803 including a content key for decrypting a content, a tag block for indicating history log collection 804 for indicating the first history log collection from the right management server 101b to the terminal device 102, an LT footer 805 as a hash value for detecting manipulation of the LT 800.

The LT header 801 comprises an LT identifier 811 for identifying the LT 800, an LT size 812 showing the length of the whole LT 800, a content ID 813 as an identifier of the content to be made available by the LT 800 and an LT validated period 814 showing the validated period of the LT 800.

The LT action tag block 802 comprises an action ID 821 for identifying a user action corresponding to the content such as “playback”, “copy”, “print” or the like, a counter for times 822 showing the available times of action execution and a use unit characteristic condition 823 showing characteristic use conditions of the content use unit 251 that plays back contents, copies them or the like. Here, the use unit characteristic condition 823 is use conditions depending on the type or performance of the content use unit 250 for using the contents in the terminal device 102. For example, sound channel indication of a movie content (it can be played back on 5.1 ch or 2ch) or the resolution of the image content, the size indication and the like.

A content key for decrypting the encrypted content is set using a binary value in the content key tag block 803.

The tag block for indicating history log collection 804 is a tag block to be generated in the history log collection indication unit 211 and has a format shown in FIG. 9. The tag block for indicating history log collection 804 comprises a history log collection indication tag value 901 that is an identifier for identifying the tag block for indicating history log collection 804, an indication information length 902 showing the length of the tag block for indicating history log collection 804 and an indication information 903 of information indicating collecting the first history logs.

The indication information 903 comprises the history log collection indication information 910 for indicating collecting the first history logs at a transaction level in the terminal device 102 and the detailed history log collection indication information 920 for indicating collecting the detailed first history logs. The history log collection indication information 910 includes the history log record condition 911, the history log description 912 and a history log response condition 913. Here, it shows indications to the terminal device 102 as follows: “for each content” of the history log record condition 911 is an indication for recording the first history logs for each unit of contents to be used, “action” and “time” of the history log description 912 of the history log description 912 are indications for recording actions showing descriptions of operations for using contents (such as playback, copy and the like) and the time when these actions are performed, “5:00 o'clock everyday” of the history log response condition 913 is an indication for sending the recorded first history logs on the contents to the right management server 101b at 5:00 o'clock everyday.

On the other hand, the detailed history log collection indication information 920 comprises the detailed history log record condition 921 and the detailed history log description 922. Here, it shows indications as follows: “for each user operation” of the detailed history log record condition 921 is an indication for recording the first history logs for each user operation on the content and the detailed history log description 922 shows indications for recording more detailed user operation descriptions and user operation time than indicated in the history log description 912.

Note that both of the history log collection indication information 910 and the detailed history log collection indication information 920 are not always specified, in other words, only the one of the two may be specified.

The LT footer 805 detects a manipulation and ensures the authenticity of the LT 800 when storing an LT800 in a nonsecure part in a hard disk or the like, and it calculates the hash value of the LT 800 and manages the calculation result (the hash value) each time the contents of the LT is updated. This hash value needs to be managed in the tamper-proof part at hardware level. As to a specific hash algorithm, Secure Hash Algorithm (SHA-1) or the like is used.

Up to this point, explanations on the detailed constructions of the LT 800 and the tag block for indicating history log collection 804 as indication information for collecting the first history logs have been made with reference to FIGS. 8 and 9, which is the end of the detailed explanation on the construction of the license processing unit 210.

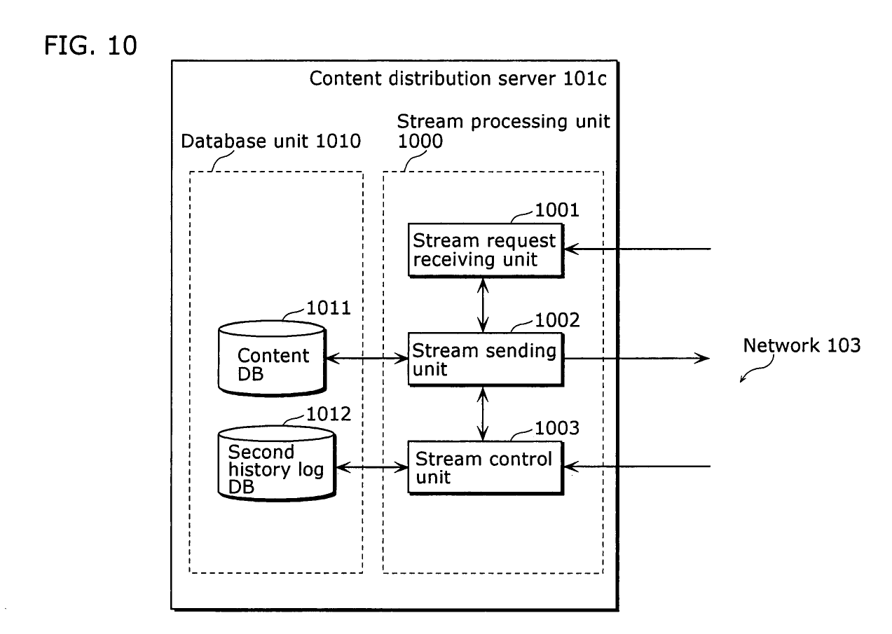

Next, FIG. 10 is a functional block diagram showing the detailed construction of the content distribution server 101c in the distribution center 101 shown in FIG. 1.

The content distribution server 101c comprises, roughly in part, a stream processing unit 1000 that is realized by a hardware such as an LSI or a program that is executed using a CPU, a RAM, a ROM or the like and a database unit 1010 that is realized by a data file or the like that is stored in an HDD or the like.

The stream processing unit 1000 comprises a stream request receiving unit 1001, a stream transmitting unit 1002 and a stream control unit 1003, and the database unit 1010 comprises a content DB 1011 and the second history log DB 1012.

The stream request receiving unit 1001 receives a stream transmitting request and a stream stop request from the terminal device 102 and notifies the stream transmitting unit 1002 of the request. More specifically, the stream request receiving unit 1001 receives a PLAY instruction by the RealTime Transport Streaming Protocol (RTSP), and then sends an instruction for transmitting the content to the stream transmitting unit 1002. Also, when it receives TEARDOWN (a stream stop request) in RTSP from the terminal device 102, it sends a transmitting stop instruction of the content to the stream transmitting unit 1002. Further, it can process a request for performing a special playback such as PAUSE (a temporal stop) in RTSP.

The stream transmitting unit 1002 reads out a stream (content) requested from the terminal device 102 from the content DB 1011 and sends it to the terminal device 102. More specifically, the stream transmitting unit 1002 acquires a content such as MPEG-2 from the content DB 1011 according to a stream control indication from the stream request receiving unit 1001, generates the RTP packet and send it to the terminal device 102.

The stream control unit 1003 controls streaming data sent from RTP and records the control information of the streaming as the second history log. More specifically, the stream control unit 1003 sends and receives the information on a packet loss or a jitter between the terminal device 102 and the content distribution server 101c using RTCP so as to realize a streaming suitable for a band width of the network 103 and records the information obtained in the RTCP in the second history log DB 1012 as the second history log.

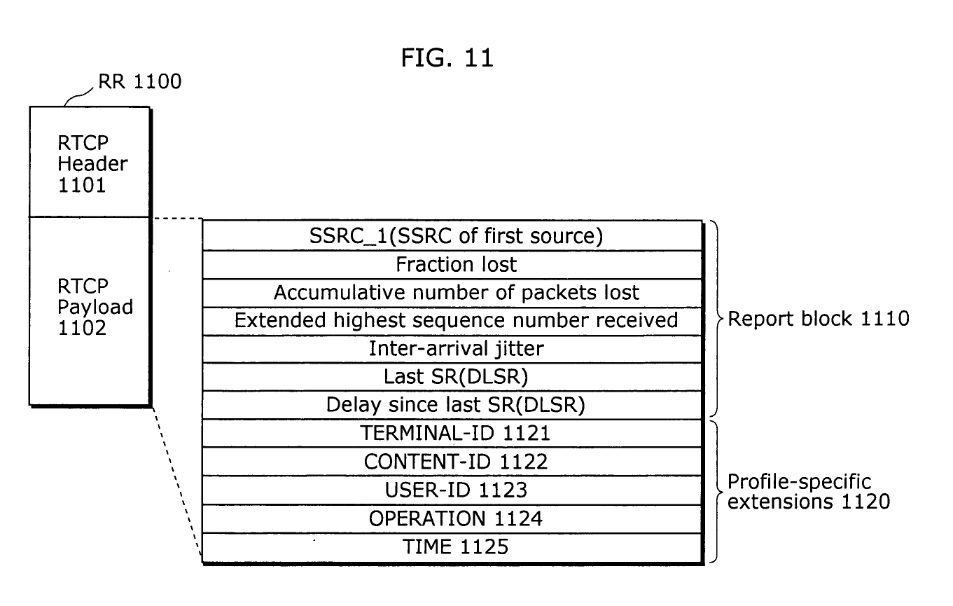

As a representative packet of the RTCP packets, the Sender Report RTCP Packet (SR) that is a report on a sender and the Receiver Report RTCP Packet (RR) that is a report on a receiver are listed. The RR of the two is data for sending the information on a packet loss, a jitter and the like obtained by the terminal device 102 to the distribution center 101. FIG. 11 shows a detailed construction of the RR 1100. The RR 1100 comprises an RTCP header 1101 (RTCP header) and an RTCP payload 1102 (RTCP payload).

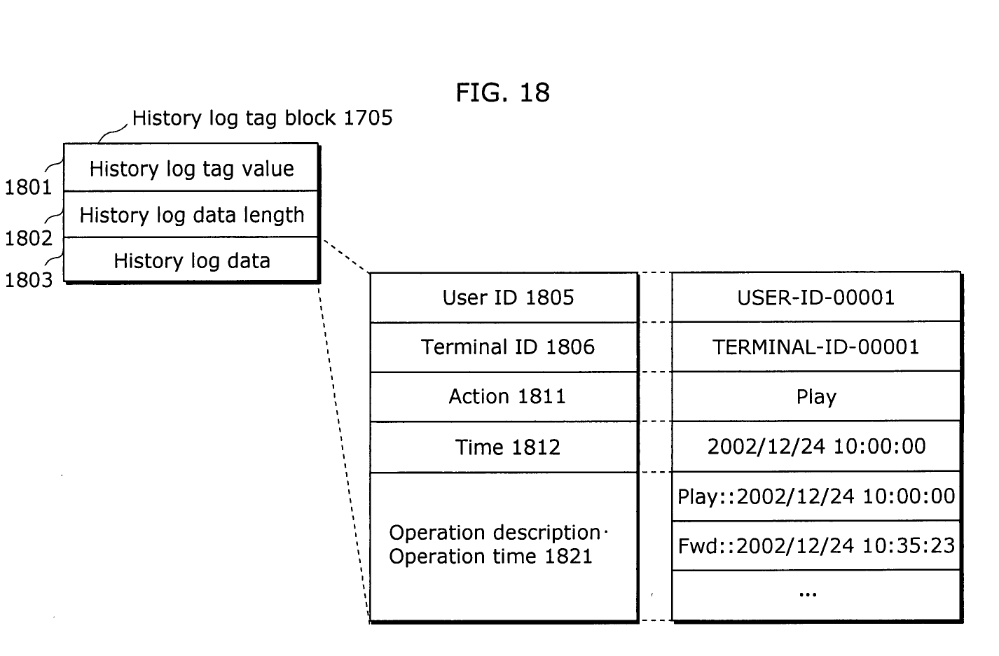

The RTCP header 1101 includes an RTCP packet length, an identifier of a sender (SSRC) and the like. The RTCP 1202 comprises a report block 1110 (report block) and a profile specific extention unit 1120 (profile-specific extentions). The profile specific extention unit 1120 of the two can include arbitrary articles, and thus it includes a terminal ID (Terminal-ID) 1121 that is an ID for identifying the terminal device 102 which generated the RR 1100 in the history log collecting system 1, a content ID 1122, a user ID 1123, an operation description 1124 (such as Play and Fwd in the operation description and time 1821 shown in FIG. 18) and an operation time 1125 (2002/12/24 10:00 in the operation description and time 1821 shown in FIG. 18).

The content DB 1011 is a database for storing contents. More specifically, the content DB 1011 associates the content encrypted in an encryption algorithm such as AES or the like with the content ID for identifying the content in the content history log collecting system 1 so as to store them.

The second history log DB 1012 is a database unit operable to store the second history log collected from the terminal device 102 via the network 103.

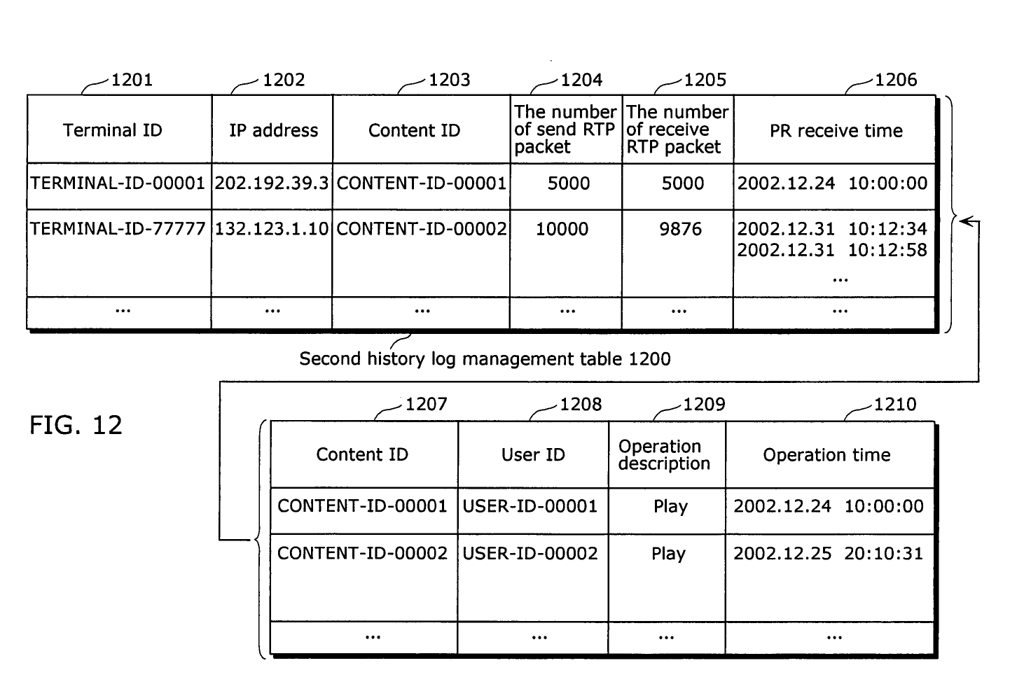

More specifically, the second history log DB 1012 stores the second history log acquired by the stream control unit 1003 from the RTCP packet. FIG. 12 shows the second history log management table 1200 managed in the second history log DB 1012. As shown in FIG. 12, the second history log management table 1200 comprises a terminal ID 1201, an IP address 1202, a content ID 1203, the number of send RTP packets 1204, the number of receive RTP packets 1205, an RR receiving time 1206, a content ID 1207, a user ID 1208, an operation description 1209 and an operation time 1210. The terminal ID 1201 is an ID for identifying the terminal device 102 that receives a streaming content and sends the second history log. The IP address 1202 is an IP address of the terminal device 102. The content ID 1203 is an ID for identifying a streaming content used by a user. The number of send RTP packets 1204 shows the total number of the RTP packet sent from the content distribution server 10c. The number of receive RTP packets 1205 shows the total number of the RTP packet received by the terminal device 102 as the second history log. The RR receiving time 1206 shows the time when the terminal device 102 receives the RR first and the receiving time of RR when a packet loss occurs. The content ID 1207 is set regarding the content ID 1122 in the received RR as a source, and it is acquired in a path different from the one used for the content ID 1203. In other words, the content ID 1207 uses the content ID 1122 in the RR payload shown in FIG. 11 as a source while the content ID 1203 is acquired from the content distribution server 10c. Likewise, the user ID 1208, the operation description 1209, the operation time 1210 are set regarding the received RR as a source.

For example, FIG. 12 shows the second history log concerning the content ID “CONTENT-ID-00001” of the terminal device 102 whose terminal ID is “TERMINAL-ID-00001”, and the number of send RTP packets 1204 from the content distribution server 101c is “5000” and the number of receive RTP packets 1205 in the terminal device 102 is “5000”, which shows that all the RTP packets are correctly received. Also, it is shown that the IP address 1202 of the terminal “TERMINAL-ID-00001” is “202. 192. 39.3”, and also it is shown that the time when the RR is received from the terminal device 102 first is “2002. 12.24 10:00:00”. Further, the operation description 1209 and the operation time 1210 show that the operation is played at 10:00:00, in December 24 of 2002. The two of content ID 1203 and 1207 match each other although they are acquired in a different path respectively, which shows that the second history log is highly authentic.

In contrast, in the case of the terminal device 102 whose terminal ID is “TERMINAL-ID-77777”, as for using a content whose content ID is “CONTENT-ID-00002”, the number of receive RTP packets 1205 is “9876” while the number of send RTP packets 1204 is “10000”, which shows that 124 pieces of RTP packets are lost. Also, the RR receiving time 1206 receives first RR at 10:12:34 in December 31 of 2002, and it is shown that the RR indicating that a packet loss occurred at 10:12:58 in December 31 of 2002 is received. The operation description 1209 and the operation time 1210 show that the operation is played at 20:10:31 in December 25 of 2002.

As to the content ID 1203 of the second history log management table 1200, the stream control unit 1003 sets the content ID used when the content distribution server 101c acquires the content to be a target of streaming from the content DB 1011. In contrast, the content ID 1207 is a content ID set in the RR and acquired in a different path.

Also, as to the RR receiving time 1206, the Last SR, that is, a time of receiving the SR lastly, of the report block 1110 set in the RR 1100 is used.

Also, an example which includes the number of receiving RTP packets 1205 is shown as the information recorded from the RR 1100 as the second history log, it is possible to record the inter-arrival jitter, that is, an average value of jitters that occur at the interval of arriving time, of the report block 1110 set in the RR 1100 or the fraction lost, that is, the RTP loss rate and use them for, for example, the assessment of the history log.

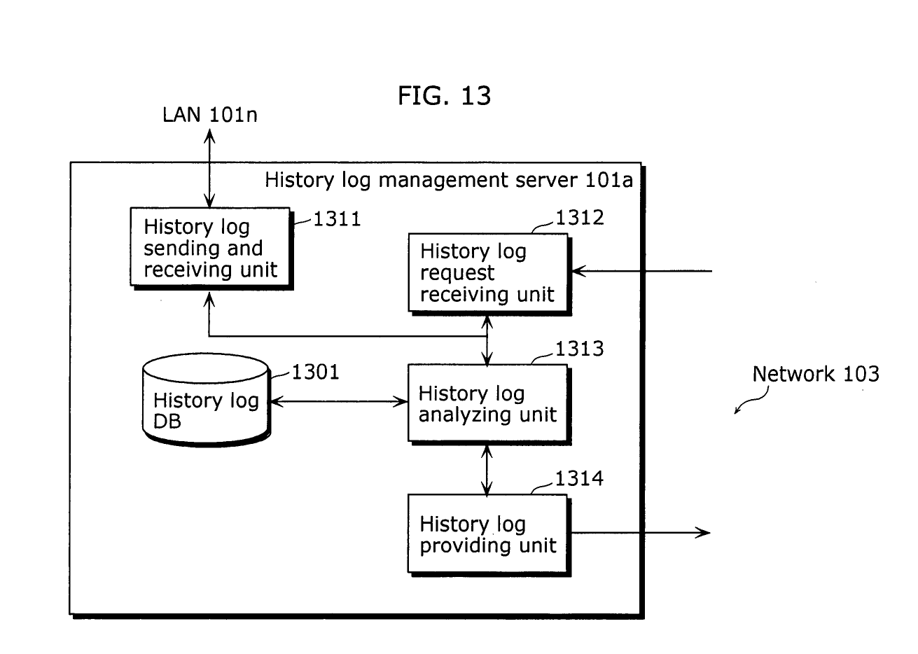

FIG. 13 is a functional block diagram showing the detailed construction of the history log management server 101e in the distribution center 101 shown in FIG. 1.

The history log management server 101e comprises a history log DB 1301, a history log sending and receiving unit 1311, a history log request sending unit 1312, a history log analyzing unit 1313 and a history log providing unit 1314.

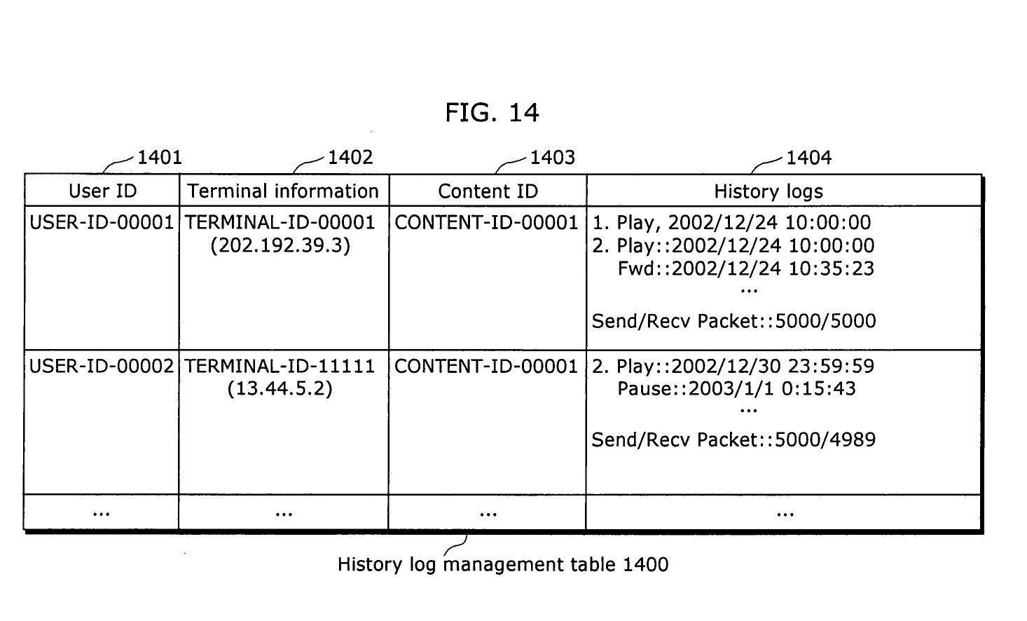

The history log DB 1301 is a database unit operable to manage history logs. More specifically, the history log DB 1301 receives the first history logs and the second history logs from the charging server 101a, the right management server 101b, the content distribution server 101c and the web server 101d, and records them in the history log management table 1400 shown in FIG. 14. The history log management table 1400 shown in FIG. 14 comprises a user ID 1401, terminal information 1402, a content ID 1403 and a history log 1404.

The user ID 1401 is an ID for identifying a user in the content history log collecting system 1.

The terminal information 1402 records an ID for identifying the terminal device 102 in the content history log collecting system 1 and an IP address (numbers shown in the parentheses).

The content ID 1403 is an ID for identifying the content used in the terminal device 102 in the content history log collecting system 1.

The history log 1401 shows the first history log sent from the terminal device 102 to the distribution center 101 and the second history log.

For example, the history log 1404 of the user “USER-ID-00001” records the first history log “1. Play, 2002/12/24 10:00:00” and “2. Play, 2002/12/24 10:00:00, Fwd::2002/12/24 10:35:23” which are acquired in the right management server 101b and the second history log “Send/Recv Packet::5000/5000” which is acquired in the content distribution server 10c. The first history log shows user's content operation processing, for example, the content “CONTENT-ID-00001” is started to play back at 10:00:00 in December 24 of 2002 and then forwarded (Fwd) at 10:35:23.

On the other hand, the second history log is information showing the ratio between the total number of the RTP packets sent by the content distribution server 101c and the total number of the RTP packets received by the terminal device 102, in this case, the information shows that all of 5000 pieces of the RTP packets sent by the content distribution server 101c are received normally in the terminal device 102. Also, the second history log of the history log 1404 of the user “USER-ID-00002” reads “Send/Recv Packet::5000/4989”, which shows that a loss of 11 packets occurred.

The history log sending and receiving unit 1311 sends and receives the first and the second history logs between the server devices except the history log management server 101e in the distribution center 101. More specifically, the history log sending and receiving unit 1311 exchanges information such as history logs between the charging server 101a, the right management server 101b, the content distribution server 101c or the like via the LAN 101n.

The history log request receiving unit 1312 receives a history log request from the terminal server 102. More specifically, the history log request from the terminal device 102 shows the processing for requesting the history log list of the user (or the terminal device 102) to the history log management server 101e from the terminal device 102 so as to present a user with the history log of the content used by the user in the past. The history log request unit 1312 receives the history log request from this terminal device 102 via the network 103 and sends the search result of the history log DB 1301 to the history log analyzing unit 1313.

The history log analyzing unit 1313 manages the history log of the history log DB 1301 and generates and provides a various kind of data by analyzing history logs. More specifically, the history log analyzing unit 1313 confirms the relationship between the first history log and the second history log or provides necessary information to another server device in the distribution center 101 such as the charging server 101a and the right management server 101b.

The history log providing unit 1314 provides the history log managed by the history log management server 101e to the terminal device 102. More specifically, the history log providing unit 1314 acquires the history logs stored in the history log DB 1301 and sends them to the terminal device 102 via the network 103.

Up to this point, the right management server 101b, the content distribution server 101c and the history log management server 101e in the distribution center 101 will be explained with reference to FIG. 2 to FIG. 14. Detailed constructions of the charging server 101a and the web server 101d of the distribution center 101 are omitted here.

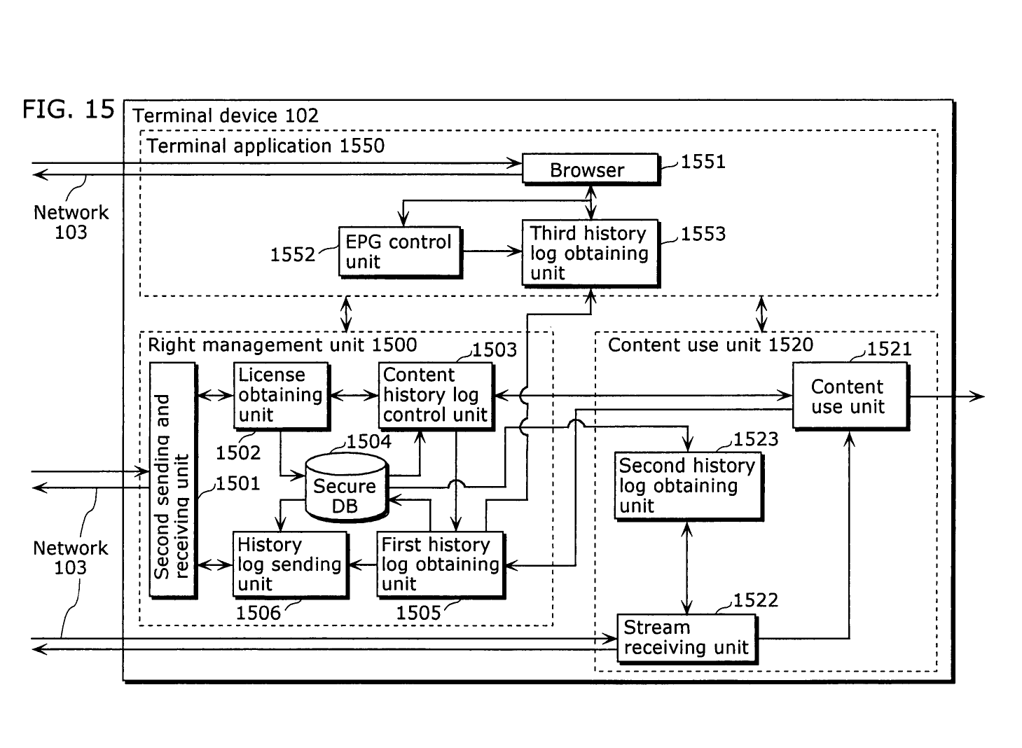

Next, the construction of the terminal device 102 in the content history log collecting system 1 will be explained. FIG. 15 is a functional block diagram showing the detailed construction of the terminal device 102 shown in FIG. 1.

The terminal device 102 comprises a right management unit 1500 for processing a license and performing content use control securely, a content use unit 1520 for using the content securely and the terminal application 1550 for mainly providing the interface to the user.

The right management unit 1500 comprises the second sending and receiving unit 1501, a license acquirement unit 1502, a content use control unit 1503, a secure DB 1504, the first history log acquirement unit 1505 and a history log sending unit 1506. Also, the content use unit 1520 comprises a content use unit 1521, a stream receiving unit 1522 and the second history log acquirement unit 1523.

The second sending and receiving unit 1501 communicates with the distribution center 101 via the network 103.

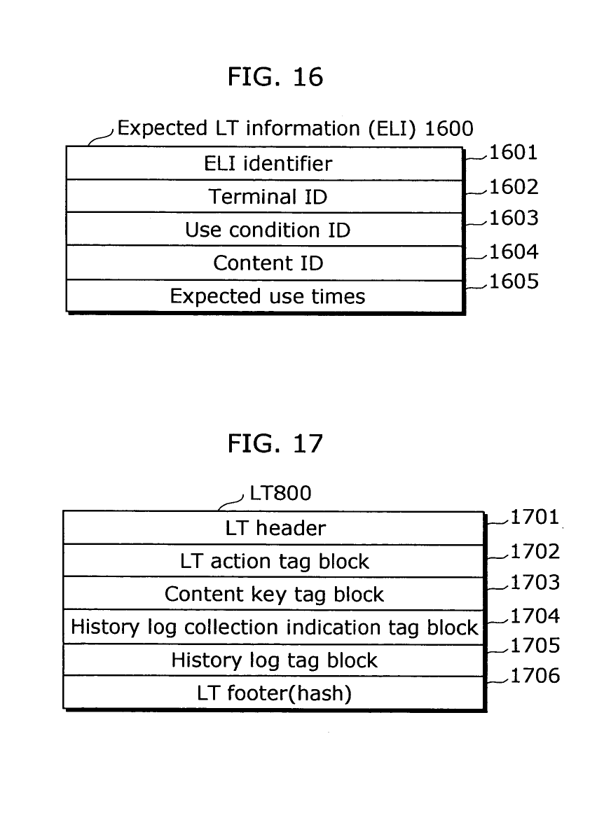

The license acquirement unit 1502 acquires an LT 800 from the right management server 101b. More specifically, the license acquirement unit 1502 generates an Expected LT Information (written as ELI below) shown in FIG. 16 and acquires the LT 800 from the right management server 101b by sending the ELI 1600 to the right management server 101b.

In FIG. 16, the ELI 1600 comprises an ELI identifier 1601, a terminal ID 1602, a use condition ID 1603, a content ID 1604 and an expected use times 1605. The information indicating that this data is the ELI 1600 is written in the ELI identifier 1601. The terminal ID of the terminal device 102 that requests for the LT 800, that is, the terminal device 102 which generated the ELI 1600 is written in the terminal ID 1602. The use condition ID 502 for identifying user's use condition managed in the use condition DB 203 of the right management server 101b is written in the use condition ID 1603. The use condition ID sent in a response when a user inquires an available right from the right management server 101b is used as this use condition ID 502.

The content ID of the desired content is written in the content ID 1604. The value of the content available times to be set in the counter for times 822 in the LT action tag block 802 of the requested LT 800 is written in the expected use times 1605. Note that it is also possible to request the expected LT validated period by a user (the LT validated period 814 in the LT header 801) in addition to the expected use times 1605.

The content use control unit 1503 performs content use control securely based on the LT 800. More specifically, the content use control unit 1503 judges whether the content is available or not based on the use condition included in the LT 800 which is acquired from the right management server 101b by the license acquirement unit 1502 when a user requests the content use control unit 1503 to use the content. After that, the processing of passing a content key for decrypting an encrypted content to the content use control unit 1521 as long as the use condition permits the content use.

For example, the content use control unit 1503 judges whether the content is available or not referring to the LT validated period 814 set in the LT header 801 of the LT 800 and the counter for times 822 set in the LT action tag block 802. It refers to the present time provided by the secure timer unit, which is not shown in FIG. 15, stored in the terminal device 102 and performs a processing of judging that it is possible to play back a content as long as the present time is within the LT validated period 814 and the value of the counter for times 822 is not less than 1.

As the content key is sent and received securely between the content use control unit 1503 and the content use unit 1521, an SAC is established and then the content key is sent and received securely.

Also, the content use control unit 1503 generated the first history log of the content as a result of the content use control. More specifically, the content use control unit 1503 performs a processing of generating the first history log at a transaction level such as user's content use times (such as playback) or the content use time and then sending it to the first history log acquirement unit 1505.

The secure DB 1504 is a database unit operable to manage data securely and stores the LT acquired by the license acquirement unit 1502 and the first history log acquired by the first history log acquirement unit 1505. More specifically, the secure DB 1504 stores the LT 800 acquired from the right management server 101b shown in FIG. 8 and the LT 800 including the first history log and stores the hash value of the LT 800 in the secure DB 1504 in the part tamper-proofed at hardware level or software level so as to prevent a user from conducting an illicit act such as manipulation. Also, the secure DB 1504 manages a terminal ID of the terminal device 102 and associates the first history log with the second history log as necessary by using a terminal ID.

The first history log acquirement unit 1505 collects the first history log from the content use control unit 1503 and the content use unit 1521. More specifically, the first history log acquirement unit 1505 receives the first history log acquired by the content use control unit 1503 or the content use unit 1521, records it in the secure DB 1504 and sends it to the history log sending unit 1506. Also, it acquires the second history log from the third history log acquirement unit 1553 and associates the second history log with the first history log.

The history log sending unit 1506 sends the first history log recorded in the terminal device 102 to the right management server 101b, sets the recorded first history log in the LT 800 in the embodiment of the present invention and sends it to the right management server 101b. More specifically, the history log sending unit 1506 searches the secure DB 1504 periodically or at an arbitrary timing, acquires the first history log (LT 800) which is uploadable to the right management server 101b by referring to the history log response condition 913 included in the tag block for collecting history logs of the LT 800 and returns the LT 800 to the right management server 101b. Otherwise, it immediately sends the first history log received from the first history log acquirement unit 1505 to the right management server 101b.

The content use unit 1521 decrypts the content, decodes it and acquires the detailed first history log.

More specifically, the content use unit 1521 acquires an encrypted download content or an encrypted streaming content, decrypts the encrypted content using a content key which is acquired from the content use control unit 1503, decodes the content and outputs it on a monitor or the like which is not shown in FIG. 15. At the same time, the detailed content history logs such as a user operation description concerning a content, information on content use time, the status of the used content and the like as the first history log and sends it to the first history log acquirement unit 1505. Also, when finishing using the content, a use end notification is sent to the content use control unit 1503. Also, the use unit characteristic condition 823 shown in FIG. 8 that is interpretable only by the content use unit 1521 is processed.

The stream receiving unit 1522 receives streaming contents via the network 103. More specifically, the stream receiving unit 1522 receives an RTP packet from the content distribution server 101c, acquires the content set in the RTP payload, grasps the receiving status of the content from information such as the RTP header and generates the second history log. Further, it receives an RTCP packet from the second history log acquirement unit 1523 and feedbacks the streaming receiving status to the content distribution server 10c.

The second history log acquirement unit 1523 acquires the second history log acquired in the stream receiving unit 1522. More specifically, the second history log acquirement unit 1523 acquires the number of RTP packets received in the stream receiving unit 1522, jitters and the like and generates an RTCP packet (RR 1100) for sending them to the distribution center 101. Also, it acquires a terminal ID from the secure DB 1504 and sets it in the RTCP packet.

The terminal application 1550 mainly comprises a browser unit 1551 operable to provide a user interface, an EPG control unit 1552 and the third history log acquirement unit 1553.

The browser 1551 is a user interface for presenting information to a user or accepting an input of the information from a user. More specifically, the browser 1551 is a web browser for referring to the information on the World Wide Web (WWW) on the Internet, acquires the website information so as to present it to a user or performs a web questionnaire using a form or the like. Otherwise, it may be a browser for providing the data of the EPG acquired from the Internet to a user.

The EPG control unit 1552 acquires the EPG data from the Internet or the like and controls the EPG display using the browser 1551. More specifically, the EPG control unit 1552 acquires the EPG data from the network 103, displays the browser 1551 and records the second history log different from the first history log, for example, how a user operates the EPG and which program (content) is used.

The third history log acquirement unit 1553 acquires the second history log recorded in the browser 1551 and the EPG control unit 1552. More specifically, the third history log acquirement unit 1553 acquires user's various kinds of second history logs from the browser 1551 or the EPG control unit 1552, sends them to the distribution center 101 via the browser 1551 on the network 103, sends the acquired second history logs to the first history log acquirement unit 1505 of the right management unit 1500 or receives the first history logs acquired by the first history log acquirement unit 1505 or the second history logs including the first history logs from the first history log acquirement unit 1505.

The components for processing data that especially require security of the terminal device 102, more specifically, the license acquirement unit 1502, a content use control unit 1503, a secure DB 1504, the first history log acquirement unit 1505, a history log sending unit 1506, a content use unit 1521 are, in general, realized in a form of a system LSI which is tamper-proofed at hardware level or a program which is tamper-proofed at software level so as to prevent a malicious user from using it illicitly.

The secure DB 1504 manages an identification (terminal ID) that is capable of identifying the terminal device 102 in the content history log collecting system 1, but an identification that is capable of identifying the right management control 1500 in the content history log collecting system 1 may be used as the terminal ID when the right management unit 1500 is detachable from the terminal device 102.

Up to this point, the detailed construction of the terminal device 102 will be explained.

Here, the construction concerning the LT 800 including the first history log generated by the content use control unit 1503 and the description of the first history log will be explained in detail with reference to FIG. 17 and FIG. 18.

FIG. 17 is a diagram showing an example of the construction of another LT 800. This LT 800 is different from the LT 800 shown in FIG. 8 in that this LT 800 includes a tag block for collecting history logs 1705 in which the first history log recorded by the terminal device 102 is set in addition to the construction of the LT 800 shown in FIG. 8. Therefore, explanations on the LT header 1701, the LT action tag block 1702, the content key tag block 1703, the tag block for collecting history logs 1704 and the LT footer 1706 are omitted here.

The history log tag block 1705 is the one in which the first history log acquired by the first history log acquirement unit 1505 is recorded and has the construction shown in FIG. 18. The history log tag block 1705 comprises a history log tag value 1801 that is an identifier for identifying the history log tag block 1705, a history log data length 1802 showing the size of the history log data 1803 and a history log data 1803 in which the actual data of the first history log is recorded. The history log data 1803 comprises a user ID 1805 for identifying a user whose first history log is recorded after using a content, a terminal ID 1806 for identifying the terminal device 102 in which the content is used, an action 1811 showing user operation descriptions that is the first history logs at a transaction level, a time 1812 showing the user operation time and an operation description and time 1821 that is the detailed first history log.

Here, it is shown that the user who used the content is the user “USER-ID-00001” and the terminal device 102 in which the content is used is the terminal device “TERMINAL-ID-00001”. Also, as the first history log acquired in the right management unit 1500 and the content use unit 1520, a user action 1811 “Play” and a user operation time 1812 “2002/12/24 10:00:00” is recorded, which shows that the playback was started at 10 o'clock in December 24 of 2002. Also, user's detailed operation description and operation time are recorded in sequence, for example, “Play::2002/12/24 10:00:00”, “Fwd::2002/12/24 10:35:23”.

In the above example, as data lengths of the action 1811, the time 1812, the operation description and time 1821 may be variable lengths, those data lengths may be added to the format of the history log data 1803 or end codes for detecting the end of the data may be assigned to it while they are not written in FIG. 18 because they are not focused on in the present invention.

Up to this point, the detailed constructions of the LT 800 including the first history log and the history log tag block 1705 have been explained with reference to FIG. 17 and FIG. 18.

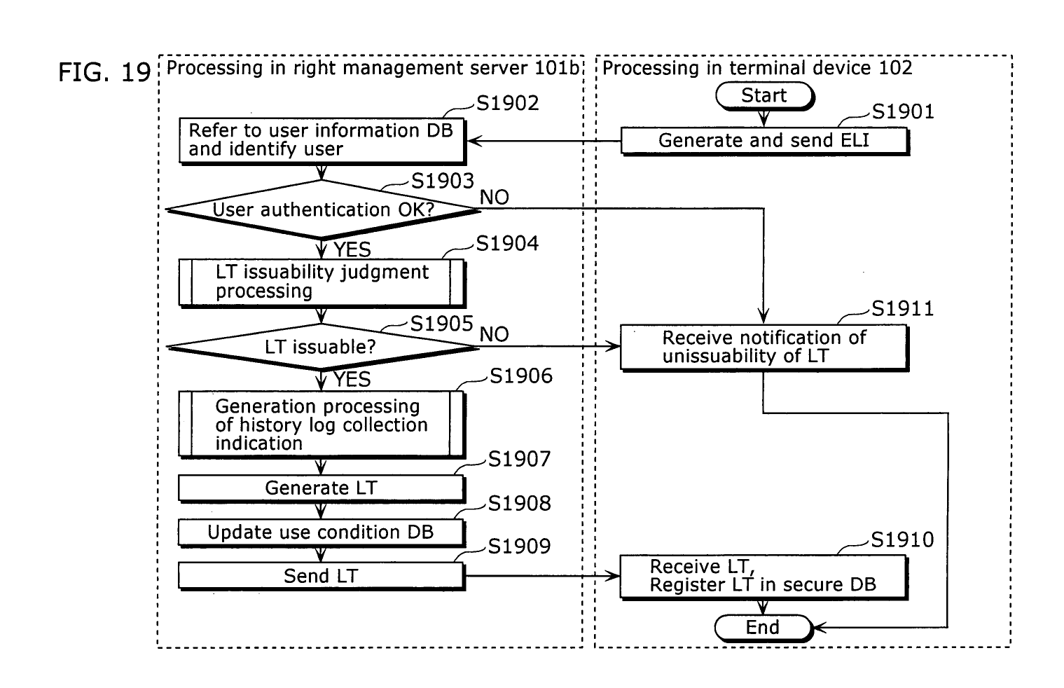

In addition, in the terminal device 102 constructed like mentioned above, the following sequential processing by a user will be explained using flow charts shown in FIGS. 19 to 26: acquiring an LT 800 from the right management server 101b and using the content securely, recording the first history log according to the use status, recording the content (stream) receiving status as the second history log, sending the first history log from the terminal device 102 to the right management server 101b and associating the first history log with the second history log in the distribution center 101 so as to use them by sending the second history log from the terminal device 102 to the content distribution server 10c.

The user needs to perform processing of registering himself or herself as a member to the service provider using a web server 101d and needs to perform a processing of purchasing content use conditions and the like before a user acquires an LT 800 from the right management server 101b, but the explanation on the processing will be omitted in the following explanation because it is not focused on in the present invention.

First, a user operation of acquiring the LT 800 from the right management server 101b in the terminal device 102 will be explained using a flow chart shown in FIG. 19.

When a user acquires user's use condition list managed in the right management server 101b using a user interface provided by the terminal application 1550 and selects the use condition of the desired content from the use condition list, the terminal device 102 generates an ELI 1600 for requesting for the LT corresponding to the use condition to the right management server 101b and sends it to the right management server 101b (step S1901).

More specifically, the content use unit 1521 receives a content ID of the content which is made available by the use condition selected by the user from the terminal application 1550 and sends it to the content use control unit 1503. The content use control unit 1503 sends the content ID to the license acquirement unit 1502. The content use control unit 1503 sends the content ID to the license acquirement unit 1502, and the license acquirement unit 1502 generates the ELI 1600 shown in FIG. 16 based on the content ID received from the content use control unit 1503.

The use condition ID 1603 set in this ELI 1600 is considered to be acquired when the terminal application 1550 or the right management unit 1500 inquires the use condition owned by a user via the right management server 101b or the web server 101d. Also, the expected use times 1605 may be set at the value desired by the user via the terminal application 1550 or at the value determined by utilizing a services. The ELI 1600 generated in this way is sent to the right management server 101b via the second sending and receiving unit 1501.

The license issuing unit 212 of the right management server 101b receives the ELI 1600 from the terminal device 102, refers to the user information DB 201 and performs a user authentication by identifying a user (step S1902).

More specifically, the user authentication is performed in two steps. In general, when exchanging data that requires security like an LT 800, an SAC is established so as to communicate securely. Therefore, as the first step, an SAC is established between the right management server 101b and the terminal device 102. In order to establish an SAC, it is possible to use the Secure Socket Layer (SSL) or the Transport Layer Security (TLS) or the like. It is possible to confirm that the terminal device 102 has a right terminal ID 1602 by this mutual authentication. As the second step, the license issuing unit 212 identifies a user who owns the terminal device 102 whose ID is the terminal ID 1602.

Therefore, the license issuing unit 212 acquires the terminal ID 1602 included in the ELI 1600, refers to the user ID 301 and the terminal ID 302 of the user information management table 300 of the user information DB 201 and searches the terminal ID 302 of the user information management table 300 that matches the terminal ID 1602 included in the ELI 1600. When the matching terminal ID 302 is found, it is possible to acquire the relating user ID 301, but when no matching terminal ID 302 is found, the user authentication fails.

The license issuing unit 212 confirms the user authentication result in the step S1902 (step S1903).

When the answer of the step S1903 is YES, that is, when a user authentication is performed correctly, step S1904 is executed because the use condition for issuing the LT 800 is confirmed.

When the answer of the step S1903 is NO, that is, when a user authentication is not performed correctly, the LT is judged as unissuable and the license issuing unit 212 sends the notification of unissuability of an LT to the terminal device 102.

The license issuing unit 212 executes the LT issuability judgment processing (step S1904). This LT issuability judgment processing will be explained in detail with reference to a figure.

The license issuing unit 212 refers to the result of the LT issuability judgment processing and judges whether the LT 800 is issuable or not (step S1905).

When the answer of the step S1905 is YES, that is, when the LT is judged to be issuable, step S1906 is executed.

When the answer of the step S1905 is NO, that is, when the LT is judged to be unissuable, the license issuing unit 212 sends the notification of unissuability of the LT to the terminal device 102.

The license issuing unit 212 requests the history log collection indication unit 211 to generate the indication information 903 for collecting the first history log shown in FIG. 9, and the history log collection indication generation processing is executed in the history log collection indication unit 211 (step S1906). This history log collection indication generation processing will be explained later in detail with reference to a figure.

The license issuing unit 212 receives the indication information 903 for collecting the first history log from the history log collection indication unit 211 and generates the LT 800 (step S1907).

More specifically, the license issuing unit 212 receives the indication information 903 from the history log collection indication unit 211 and generates the tag block for collecting history logs 804. Also, it refers to the ELI 1600 and the use condition management table 500 of the use condition DB 203, acquires the content key 402 corresponding to the content ID 1604 (content ID 401) from the content key management table 400 of the content key DB 202 and generates the LT 800 including the use condition requested by the ELI 1600.

The license issuing unit 212 updates the use condition management table 500 of the use condition DB 203 (step S1908). More specifically, the license issuing unit 212 performs subtracting the use condition included in the issued LT 800 from the use condition of the user. For example, when the counter for times 822 of the LT action tag block 802 of the LT 800 is “3” on condition that the available times 505 of the use condition management table 500 is “5”, the processing of updating the available times 505 of the use condition management table 500 to “2”.

The license issuing unit 212 sends the LT 800 generated in step S1907 to the terminal device 102 (step S1909). More specifically, the license issuing unit 212 sends the LT 800 to the terminal device 102 via the first sending and receiving unit 214.

The license acquirement unit 1502 of the terminal device 102 receives the LT 800 from the right management server 101b and registers the LT 800 in the secure DB 1504 (step S1910). More specifically, the license acquirement unit 1502 acquires the LT 800 as a response to the ELI 1600 generated in step S1901 via the second sending and receiving unit 1501, writes the LT 800 in the secure DB 1504 and updates the hash value of the secure DB 1504.

When a notification of unissuability of the LT is sent because the LT 800 is unissuable, the license acquirement unit 1502 of the terminal device 102 receives the notification of unissuability of the LT in the step S1903 or step S1905 (step S1911). More specifically, the license acquirement unit 1502 of the terminal device 102 receives the notification of unissuability of the LT from the right management server 101b and notifies the user of receiving the notification via a user interface of the terminal application 1550 to finish this processing.

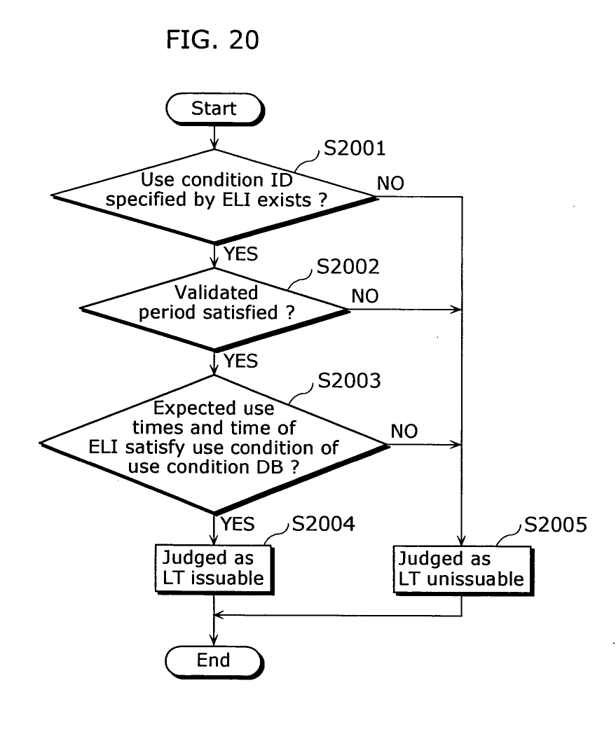

Here, the LT issuability judgment processing in the step S1904 will be explained with reference to FIG. 20.

First, the license issuing unit 212 confirms whether the use condition ID 1603 specified by the ELI 1600 is included in the use condition management table 500 of the use condition DB 203 (step S2001). More specifically, the license issuing unit 212 refers to the ELI 1600 received from the terminal device 102 and acquires the use condition ID 1603. It is confirmed whether there is any use condition ID 502 in the use condition management table 500 that matches this use condition ID 1603.

When the answer of the step S2001 is YES, that is, the use condition ID 502 that matches the use condition ID 1603 of the ELI 1600 is included in the use condition management table 500, it is further confirmed whether the user ID 501 that has the use condition ID 502 matches the user ID 301, which is authenticated in the step S1902 in FIG. 19 in the user information management table 300 of the user information DB 201. Here, step S2002 is executed when the user IDs match each other, or step S2005 is executed when the user ID does not match.

When the answer of the step S2001 is NO, that is, when no use condition ID 502 that matches the use condition ID 1603 of the ELI 1600 is included in the use condition management table 500, step S2005 is executed.

Next, the license issuing unit 212 judges whether the user use condition satisfies the validated period or not (step S2002). More specifically, the license issuing unit 212 refers to the validated period 504 in the use condition management table 500 of the use condition DB 203, acquires the present time from the secure timer unit (not shown in FIG. 2) and judges whether the present time is included in the period between the starting date and time and the finishing date and time shown by the validated period 504.

For example, when the present time is “2002/12/18 12:34:56” on condition that the validated period 504 in the use condition management table 500 is “2002/12/20 12:12:12”, it is judged that the user use condition is within the validated period. On the other hand, when the present time is “2002/12/31 19:00:00”, it is judged that the user use condition is not within the validated period.

When the answer of the step S2002 is YES, that is, when the user use condition is within the validated period, step S2003 is executed.

When the answer of the step S2002 is NO, that is, when the user use condition is not within the validated period, step S2005 is executed.

The license issuing unit 212 judges whether the expected use times 1605 of the ELI 1600 is within the use condition owned by a user (step S2003). More specifically, the license issuing unit 212 confirms whether the expected use times 1605 specified by the ELI 1600 is within the available times 505 of the use condition management table 500. For example, when the expected use times 1605 specified by the ELI 1600 is “3” when the available times 505 of the use condition management table 500 is “5”, it is judged that the expected use times 1605 specified by the ELI 1600 is included in the user use condition. On the other hand, the expected use times 1605 specified by the ELI 1600 is “10”, it is judged that the expected use times 1605 specified by the ELI 1600 is not included in the user use condition.

The answer of the step S2003 is YES, that is, when the expected use times 1605 is included in the user use condition, step S2004 is executed.

The answer of the step S2003 is NO, that is, when the expected use times 1605 is not included in the user use condition, step S2005 is executed.

The license issuing unit 212 judges that the LT 800 is issuable and finishes the LT issuability judgment processing (step S2004).

Also, when the answers of the step S2001 to S2003 is NO, that is, when the license issuing unit 212 is judged that the LT 800 is unissuable, the LT issuability judgment processing is finished (step S2005).

Up to this point, the LT issuability judgment processing has been explained with reference to FIG. 20.

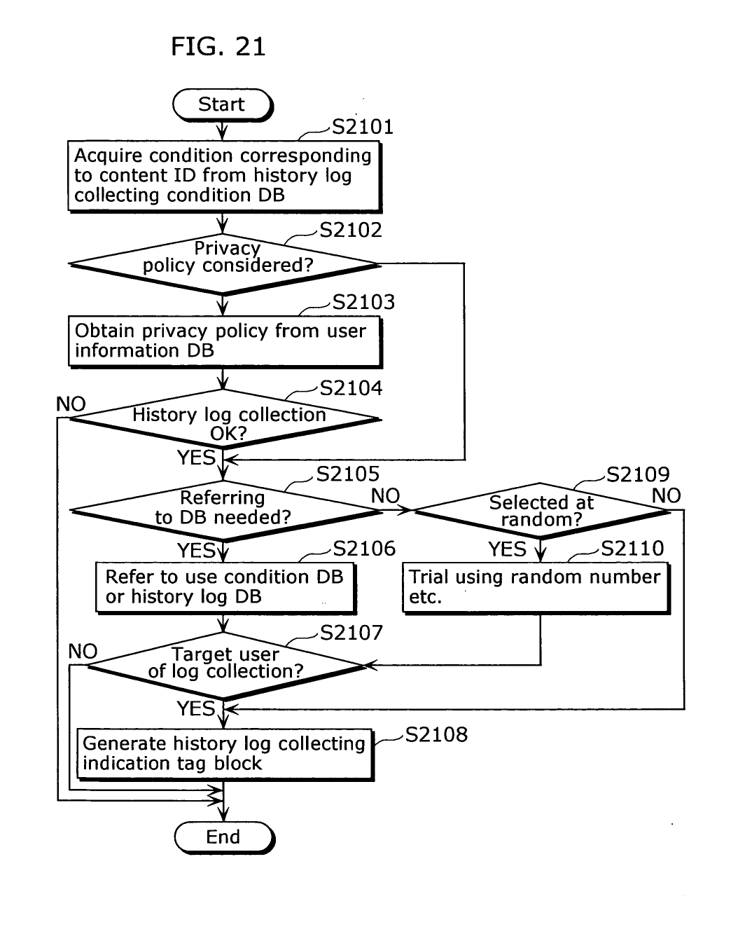

Also, the history log collection indication generation processing in the step S1906 will be explained with reference to FIG. 21.

The history log collection indication unit 211 acquires the history log collection condition 602 and the like corresponding to the content ID 1604 specified by the ELI 1600 from the history log collection condition DB 204 (step S2101). More specifically, the history log collection indication unit 211 refers to the history log collection condition management table 600 of the history log collection condition DB 204 and acquires the history log collection condition 602 whose content ID 601 matches the content ID 1604 specified by the ELI 1600.

Next, the history log collection indication unit 211 judges whether the target user determination condition 603 of the history log collection condition 602 acquired in the step 52101 needs to consider the user's privacy policy or not (step S2102). More specifically, the history log collection indication unit 211 refers to the target user determination condition 603 and judges that the privacy policy set by the user needs to be considered when collecting the first history log concerning the content. For example, here is an example case where the target user determination condition 603 whose content ID 601 is “CONTENT-ID-00003” in FIG. 6 is set in a way that the privacy policy is considered.

When the answer of step S2102 is YES, that is, when the user privacy policy needs to be considered, step S2103 is executed.

When the answer of step S2102 is NO, that is, when the user privacy policy needs to be considered, step S2105 is executed.

The history log collection indication unit 211 refers to the user information DB 201 and acquires the user privacy policy (step S2103). More specifically, the history log collection indication unit 211 acquires the privacy policy 304 in the user information management table 300 in the user information DB 201.

The history log collection indication unit 211 refers to the privacy policy 304 acquired in the step S2103 and judges whether the user permits the service provider to collect the first history log or not (step S2104). More specifically, when the privacy policy 304 is “history log collecting OK” or “detailed history log collecting OK”, the history log collection indication unit 211 judges that collecting the first history log is permitted. On the other hand, when the privacy policy 304 is “history log collecting NG”, it judges that collecting the first history log is rejected.

When the answer of the step S2104 is YES, that is, when collecting the first history log is OK, step S2105 is executed.

When the answer of the step S2104 is NO, that is, when collecting the first history log is NG, there is no need to generate the history log collection indication information 910 or the detailed history log collection indication information 920 and the processing finishes.

The history log collection indication unit 211 further judges whether there is a need to refer to the various databases in the right management server 101b or not so as to determine the user whose first history log is to be collected (step S2105). More specifically, the history log collection indication unit 211 refers to the target user determination condition 603 acquired in the step S2101 and judges whether there is a need to refer to the use condition DB 203 or the first history log DB 205 or the like. For example, as a user is determined as the target user whose first history log is to be collected when 5 or more user history logs are included in the first history log DB 205, the target user determination condition 603 of the content whose content ID 601 in FIG. 6 is “CONTENT-ID-00002” is “5 or more history logs”, the first history log DB 205 needs to be referred to.

In other words, the target user determination condition 603 of the content whose content ID 601 is “CONTENT-ID-00004” is “10 or more user rights”, and a user is determined as the target user whose first history log is to be collected only when 10 or more use conditions of the user are included in the use condition DB 203, access to the use condition DB 203 occurs.

When the answer of the step S2105 is YES, that is, when accesses to the databases occur so as to determine the target user whose first history log is to be collected, step S2106 is executed.

When the answer of the step S2105 is NO, that is, when no access to the database occurs so as to determine the target user whose first history log is to be collected, step S2109 is executed.

The history log collection indication unit 211 refers to the database according to the condition written in the target user determination condition 603 and acquires the data concerning the user (step S2106).

The history log collection indication unit 211 judges whether a user is determined as the target user whose first history log is to be collected based on the information acquired from the database (step S2107). More specifically, the history log collection indication unit 211 refers to the data concerning the user acquired in the step S2106 and judges whether it satisfies the target user determination condition 603 or not. For example, in the case of the content ID 601 in FIG. 6, which is the content whose ID is “CONTENT-ID-00002”, when the first history log of the user acquired from the first history log management table 700 of the first history log DB 205 in the step S2106 is “10”, the user is determined as the target user whose first history log is to be collected.

On the other hand, when the first history log of the user acquired from the first history log management table 700 of the first history log DB 205 in the step S2106 is “3”, the user is not determined as the target user whose first history log is to be collected because it does not satisfy the target user determination condition 603 of the history log collection condition management table 600. Here, the first history log recorded in the first history log DB 205 is referred to, but it is possible to use the history log managed in the history log management server 101e.

The history log collection indication unit 211 generates a tag block for collecting a history log 804 (step S2108). More specifically, the history log collection indication unit 211 generates a tag block for collecting a history log 804 shown in FIGS. 8 and 9 based on the history log collection condition management table 600.

Also, when the answer of the step S2105 is NO, the history log collection indication unit 211 refers to the target user determination condition 603 and judges whether a user whose first history log is to be collected is selected at random or not (step S2109).

When the answer of the step S2109 is YES, that is, when a user whose first history log is to be collected is selected at random, step S2110 is executed.

When the answer of the step S2109 is NO, that is, when it is judged that the first history logs are to be collected from all users, step S2108 is executed so as to generate a tag block for collecting a history log 804.

The history log collection indication unit 211 performs a trial using random numbers or the like and generates data for selecting a target user whose first history log is to be collected (step S2110). After that, step S2107 is executed.

As the history log collection indication generation processing of the step S1906 has been explained up to this point, an explanation on the operation for acquiring an LT 800 from the right management server 101b by the terminal device 102 will be finished.

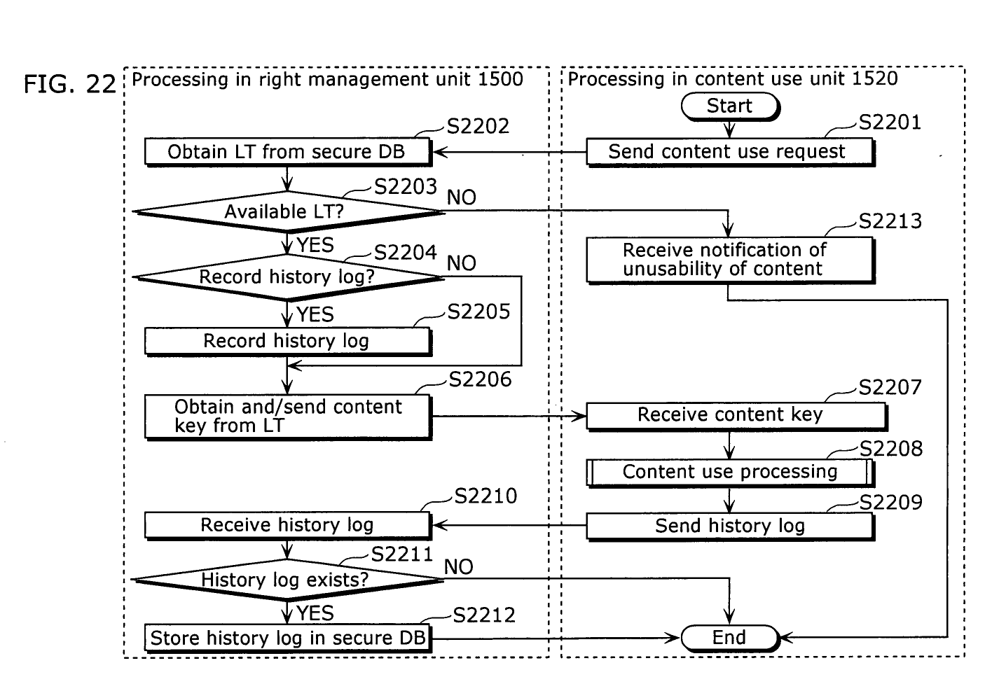

Next, the user operation for using a content and recording the first history log and the second history log in the terminal device 102 will be explained using a flow chart shown in FIG. 22.

First, a user selects a content for use from the streaming content list on the web display screen provided by the web server 101d or the like via the browser 1551 of the terminal application 1550. The content use unit 1520 in the terminal device 102 sends the content ID of the content received from the terminal application 1550 to the right management unit 1500 (step S2201). More specifically, the content use unit 1521 of the content use unit 1520 receives the Uniform Resource Identifier (URI) showing the content ID selected by the user and the location of the content from the terminal application 1550, sends the content ID to the content use control unit 1503 of the right management control unit 1500 and requests for the content use. The following explanation will be made providing that using a content means playing back a content in the embodiment of the present invention.

The content use control unit 1503 acquires an LT 800 corresponding to the content ID from the secure DB 1504 (step S2202). More specifically, the content use control unit 1503 searches the secure DB 1504 using the content ID received from the content use unit 1521 as a key.

The content use control unit 1503 acquires an LT 800 searched in the step S2202 and judges whether the LT is an available LT 800 or not (step S2203). More specifically, the content use control unit 1503 confirms whether the LT 800 corresponding to the content ID specified by the content use unit 1521 is included in the secure DB 1504 or not first. When the LT 800 is included, it refers to the LT validated period 814 or the counter for times 822 of the LT 800 and confirms the validity of the LT 800.

The validity of the LT validated period 814 is confirmed using time information acquired from a secure timer unit (not shown in FIG. 15) in the terminal device 102. Also, it is confirmed that the value of the counter for times 822 of the LT 800 is “1” or more. When the LT 800 corresponding to the content ID specified by the content use unit 1521 does not exist in the secure DB 1504, step S2213 is executed.

When the answer of the step S2203 is YES, that is, when it is judged that the LT 800 is available, step S2204 is executed.

When the answer of the step S2203 is NO, that is, when it is judged that the LT 800 is available, step S2213 is executed.

The content use control unit 1503 judges whether the first history log is recorded or not when using the content (step S2204). More specifically, the content use control unit 1503 detects the presence or absence of a tag block for collecting a history log 804 of the LT 800 acquired from the secure DB 1504 and determines whether the first history log should be recorded or not. Note that it is also possible to determine whether the first history log should be recorded by referring to the description of the tag block for collecting a history log 804 or referring to the information concerning another history log collection indication which can be understood by the content use control unit 1503 in addition to the method for determining whether the first history log should be recorded or not based on the presence or absence of the tag block for collecting a history log 804 of the LT 800.

When the answer of the step S2204 is YES, that is, when it is judged that the first history log should be recorded, step S2205 is executed.

When the answer of the step S2204 is NO, that is, when it is judged that the first history log should not be recorded, step S2206 is executed.

The content use control unit 1503 records the first history log (step S2205). More specifically, the content use control unit 1503 refers to the history log collection indication information 910 in the indication information 903 of the tag block for collecting a history log 804 and records the first history log according to the indication description. For example, as shown in FIG. 9, “action” and “time” are included in the history log collection indication information 910 as the history log description 912, not only the date and time information acquired from the secure timer unit (not shown in FIG. 15) but also “Play” as the action specified by a user are recorded.

When the history log collection indication information 910 is not included in the indication information 903, the first history log in the content use control unit 1503 is not recorded. In contrast, when the detailed history log collection indication information 920 is not included in the indication information 903, the first history log in the content use unit 1521 is not recorded. The first history log recorded in this way is sent to the first history log acquirement unit 1505.

The content use control unit 1503 acquires a content key, and sends it to the content use unit 1521 (step S2206). More specifically, the content use control unit 1503 acquires the content key from the content key tag block 803 of the LT 800 and sends it to the content use unit 1521 on the SAC. At the same time of sending a content key, the content use control unit 1503 sends the detailed history log collection indication information 920 in the indication information 903 included in the tag block for indicating history log collection of the LT 800 and specifies the collection of the first history log in the content use unit 1521.

The content use unit 1521 acquires a content key, decrypts an encrypted content and plays back the content (step S2207). More specifically, the content use unit 1521 receives a content key from the content use control unit 1503 and acquires the encrypted content using a URI of the content acquired from the terminal application 1550. Also, it decrypts the encrypted content using the content key, decodes the content and outputs the content on a monitor or the like which is not shown in FIG. 15.

The content use unit 1521 continues the content use processing (playback processing) and acquires the detailed first history log (step S2208). This content use processing will be explained in detail with reference to a figure.

The content use unit 1521 sends the first history log acquired when using a content to the first history log acquirement unit 1505 (step S2209).

The first history log acquirement unit 1505 receives the first history log from the content use unit 1521 (step S2210).

The first history log acquirement unit 1505 judges whether the valid first history log, which is recorded in the content use control unit 1503 and the content use unit 1521, is acquired or not (step S2211). More specifically, the processing is for judging whether the first history log should be stored in the secure DB 1504 or not because the first history log may not have been recorded depending on the description of the indication information 903 of the tag block for collecting a history log 804 or the presence or absence of the indication information 903.

When the answer of the step S2211 is YES, that is, when the valid first history log is recorded, step S2212 is executed.

When the answer of the step S2211 is NO, that is, when the valid first history log is not recorded, this processing finishes.

The first history log acquirement unit 1505 stores the first history log in the secure DB 1504 (step S2212). More specifically, the first history log acquirement unit 1505 inserts the history log tag block 1705 for writing the first history log in which history log data 1803 is set into the LT 800 as shown in FIGS. 17 and 18. The first history log written in the LT 800 in FIG. 17 is written in the secure DB 1504 so as to update the secure DB 1504.

When there is no available LT 800 in the step S2203, the content use unit 1521 receives a notification of unusability of the content from the content use control unit 1503 (step S2213). The content use unit 1521 notifies the user of receiving the notification via a user interface provided by the terminal application 1550.

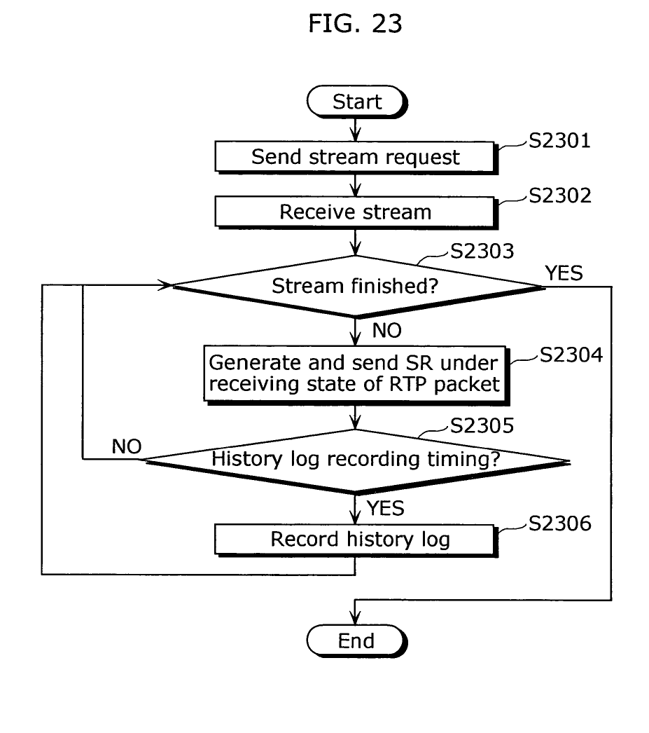

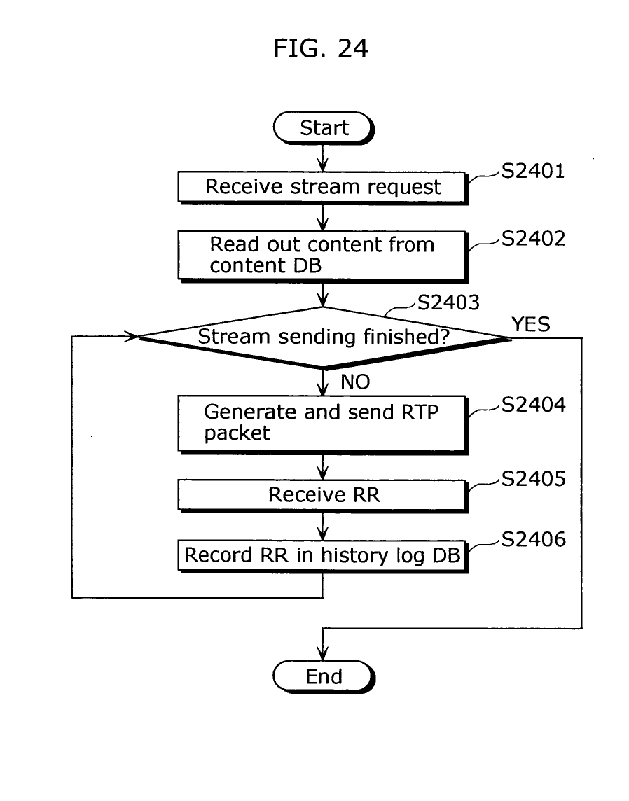

Here, the content use processing in the step S2208 will be explained with reference to FIGS. 23 and 24. FIG. 23 shows the content use processing in the terminal device 102, and FIG. 24 shows the content use processing in the content distribution server 101C.

First, the content use processing in the terminal device 102 will be explained with reference to FIG. 23.

The content use unit 1521 sends a stream (content) request to the content distribution server 101c (step S2301). More specifically, the content use unit 1521 connects with the content distribution server 101c based on the URI of the content received from the terminal application 1550 and sends the playback request (PLAY) using the RTSP. The content distribution server 101c sends a corresponding content to the terminal device 102 using the RTP.

The stream receiving unit 1522 receives a stream from the content distribution server 101c (step S2302). More specifically, the stream receiving unit 1522 receives an RTP packet sent from the content distribution server 101c in sequence, measures the reception status based on the RTP header information, sends it to the second history log acquirement unit 1523 and sends the RTP payload to the content use unit 1521 in sequence. The content use unit 1521 acquires data such as content video and music from the RTP payload received from the stream receiving unit 1522, decodes it and outputs it on a monitor or the like which is not shown in FIG. 15.

The stream receiving unit 1522 judges whether the stream from the content distribution server 101c finished or not (step S2303). More specifically, the stream receiving unit 1522 detects the end of the stream using a method such as a method for judging whether the received RTP packet is the last packet or not.

When the answer of the step S2303 is NO, that is, when it is impossible to finish receiving a stream, step S2304 is executed.

When the answer of the step S2303 is YES, that is, when the completion notification of content use is received from a user via the terminal application 1550 or when the stream is fully received, it notifies the user of the fact that the stream has been received via the terminal application 1550 and finishes this processing.

The second history log acquirement unit 1523 generates the RR 1100 from the receiving status of the RTP packet and sends the RR 1100 to the content distribution server 101c (step S2304). More specifically, the second history log acquirement unit 1523 receives the receiving status of the RTP packet from the stream receiving unit 1522 and generates the RR 1100 as the second history log. Here, the terminal ID acquired from the secure DB 1504 is set as the TERMINAL-ID in the profile characteristic extension unit 1120 in the RTCP payload 1102 of the RR 1100. Further, the second history log acquirement unit 1523 may set a user ID, an operation time, an operation description and the like in the profile characteristic extension unit 1120. The second history log acquirement unit 1523 sends the generated RR 1100 to the stream receiving unit 1522, and the stream receiving unit 1522 sends the RR 1100 to the content distribution server 101c in sequence.

Here, a terminal ID and the like of the terminal device 102 is set in the profile characteristic extension unit 1120, but it is possible to set a terminal ID in the CNAME of the RTCP packet. Also, it is possible to use the CNAME of the RTCP packet as the terminal ID on condition that the CNAME is capable of identifying the terminal device 102 in the content history log collecting system 1.

The content use unit 1521 refers to the description of the detailed history log collection indication information 920 and judges whether the present time is the appropriate timing for recording the first history log or not (step S2305). More specifically, the content use unit 1521 judges whether the indication for recording the first history log is made at present time or not based on the detailed history log record condition 921 of the detailed history log collection indication information 920. For example, when the second history log collection record condition 921 is “for each user operation”, a judgment as to whether the processing for recording the detailed first history log should be performed or not is made depending on whether a user operation occurs or not at the time of executing this step. In other words, when the indication of recording “the first history log at the interval of 10 seconds” is made as the second history log collection record condition 921, counting 10 seconds as the interval using any timer unit and notifying a user of the appropriate timing for recording the first history log to this step makes it possible to judge whether the first history log should be recorded or not.

When the answer of the step S2305 is YES, that is, when it is judged to be the timing for recording the first history log, step S2306 is executed.

When the answer of the step S2305 is NO, that is, when it is judged to be not the timing for recording the first history log, step S2303 is executed.

The content use unit 1521 records the first history log and sends the recorded first history log to the first history log acquirement unit 1505 (step S2306). After that, step S2303 is executed.

When a completion notification of content use from the content use unit 1521 or any other notification occurs in the step S2210 in FIG. 22, it is possible to record the first history log in the content use control unit 1503 and send the first history log to the first history log acquirement unit 1505. For example, it is possible to acquire the history log (which may include time information) concerning “the completion of content use” at this timing.

Next, the content sending processing of the content distribution server 101c in the content use processing of the terminal device 102 will be explained with reference to FIG. 24.

The stream request receiving unit 1001 in the stream processing unit 1000 of the content distribution server 101c receives the stream request from the terminal device 102 (step S2401). More specifically, the stream request receiving unit 1001 receives a playback request by the RTSP from the terminal device 102, acquires the requested content ID and sends the content ID to the stream transmitting unit 1002.

The stream transmitting unit 1002 reads out the content with the content ID from the content DB 1011 (step S2402). More specifically, the stream transmitting unit 1002 searches the content DB 1011 using the content ID received from the stream request receiving unit 1001 as the key and acquires the content.

The stream transmitting unit 1002 judges whether the transmission of the read-out content is finished or not (step S2403). More specifically, the stream transmitting unit 1002 divides the content read out from the content DB 1011 into RTP packets and judges whether all the RTP packets have already been transmitted or not.

When the answer of the step S2403 is NO, that is, when a stream has not been transmitted yet, step S2404 is executed.

When the answer of the step S2403 is YES, that is, when a stream has already been transmitted, this processing is finished.

The stream transmitting unit 1002 generates an RTP packet and sends it to the terminal device 102 (step S2404). More specifically, the stream transmitting unit 1002 divides the read-out content into parts at a certain size, adds an RTP header to the content, generates an RTP packet and transmits it to the terminal device 102 in sequence.

The stream transmitting unit 1002 receives an RR 1100 to be transmitted from the terminal device 102 in sequence (step S2405). More specifically, the stream transmitting unit 1002 sends the RTP packet of the content to the terminal device 102, receives the RR 1100 showing the receiving status of the RTP packet, which is reported from the terminal device 102 in sequence, of the terminal device 102 as the second history log and acquires the second history log in the terminal device 102.

The stream control unit 1003 receives an RR 1100 from the stream transmitting unit 1002, controls the transmission of the RTP packet according to the RR 1100 and stores the RR 1100 in the second history log DB 1012 (step S2406). More specifically, the stream control unit 1003 analyzes the RR 1100 and uses the result for band control or adjustment of transmission data amount or the like. Also, it acquires the RRs 1100 as the second history logs and writes part or all of the second history logs in the second history log DB 1012. After that step S2403 is executed.

In this way, the second history logs acquired by the content distribution server 101c are sent to the history log management server 101e immediately, and thus the history log management server 101e can acquire a content rating in the terminal device 102 in real-time.

Transmission of the SR or the Source Description RTCP Packet (SDES) or the like in the RTCP packet in the stream transmitting unit 1002 of the content distribution server 101c is not described here in special, but it is possible to send the information concerning the second history log collection to the terminal device 102 using the SR or the SDES as necessary.

Up to this point, the operation for using the content in the terminal device 102, recording the first and the second history logs and sending the second history log to the content distribution server 101c will be explained.

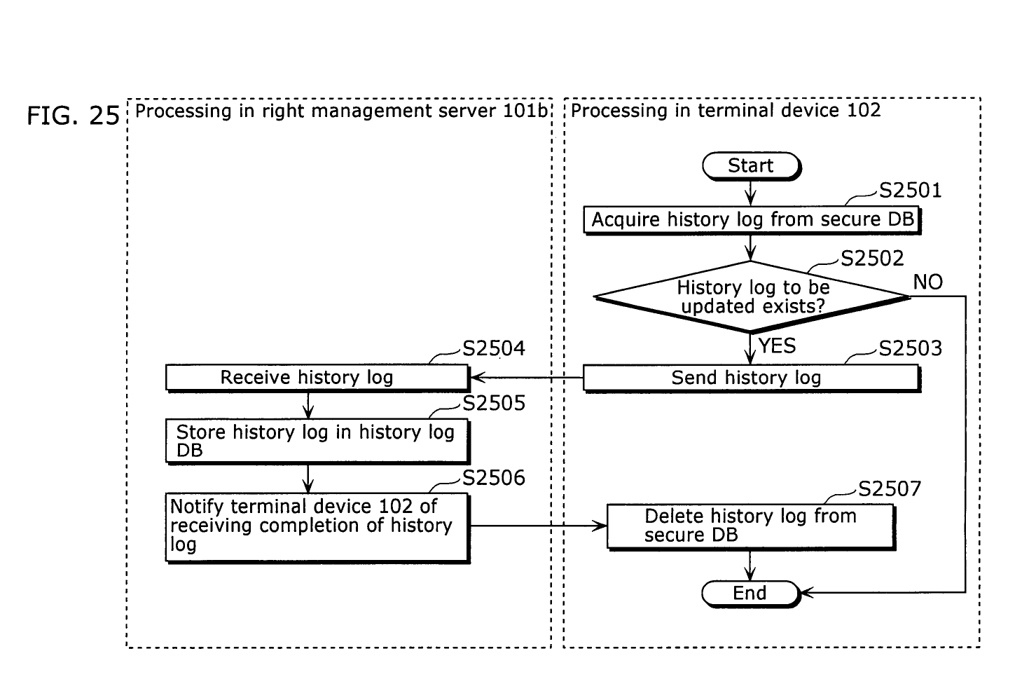

Next, the operation for sending the first history log recorded in the terminal device 102 to the right management server 101b using the LT 800 will be explained with reference to the flow chart shown in FIG. 25.

The history log sending unit 1506 of the terminal device 102 acquires the first history log (LT 800) that should be sent to the right management server 101b from the secure DB 1504 (step S2501). More specifically, the history log sending unit 1506 searches all the LTs 800 in the secure DB 1504 and refers to the history log response condition 913 in the indication information 903 of the tag block for indicating history log collection 804. Here, when it satisfies the response condition of the first history log, the LT 800 is acquired as the first history log to be sent to the right management server 101b from the secure DB 1504.

The history log sending unit 1506 confirms the presence or absence of the LT 800 to be sent to the right management server 101b as the result of the step S2501 (step S2502).

When the answer of the step S2502 is YES, that is, when the LT 800 to be sent to the right management server 101b is included, step S2503 is executed.

When the answer of the step S2502 is NO, that is, when no LT 800 to be sent to the right management server 101b is included, this processing finishes.

The history log sending unit 1506 sends the first history log to the right management server 101b (step S2503). More specifically, the history log sending unit 1506 sends the LT 800 that includes the first history log to the right management server 101b via the second sending and receiving unit 1501.

The history log receiving unit 213 of the right management server 101b receives the first history log from the terminal device 102 (step S2504). More specifically, the history log receiving unit 213 receives the LT 800 as the first history log from the terminal device 102 via the first sending and receiving unit 214.

The history log receiving unit 213 stores the history logs in the first history log DB 205 (step S2505). More specifically, it writes the data of the history log tag block 1105 included in the LT 800 received from the terminal device 102 in the first history log management table 700 and updates the data. Note that it is possible to send the first history log to the history log management server 101e immediately.

The history log receiving unit 213 sends a completion notification of receiving history logs to the terminal device 102 (step S2506).

The history log sending unit 1506 of the terminal device 102 completely deletes the LT 800 sent to the right management server 101b (step S2507) by updating (committing) the secure DB 1504 sent at the time of receiving the completion notification of the history logs from the right management server 101b.

Up to this point, the operation for sending the first history log to the right management server 101b by the terminal device 102 has already been explained.

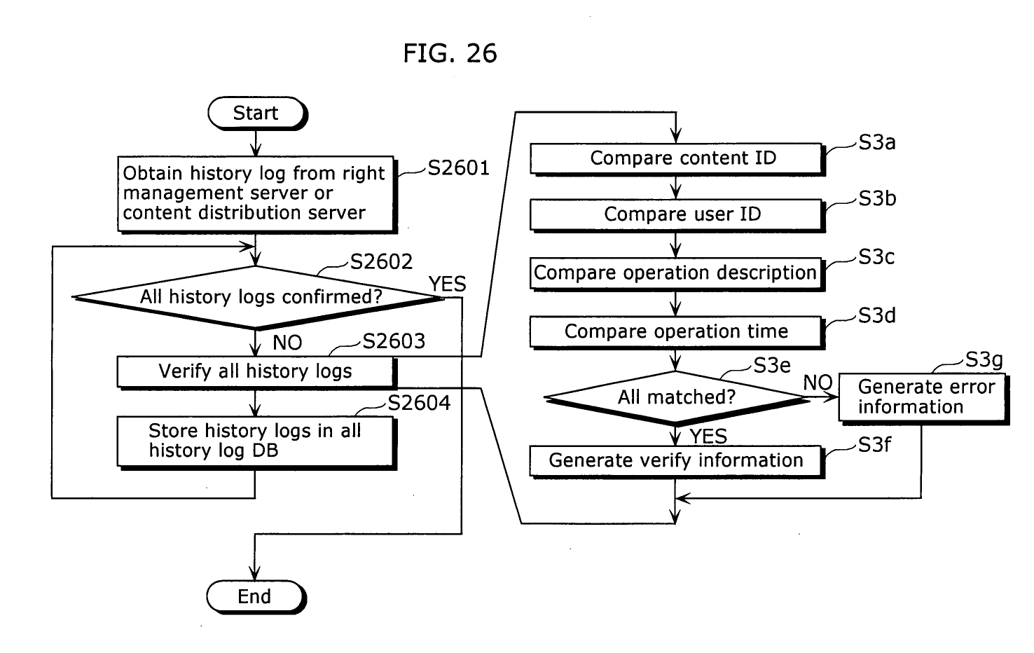

Lastly, the operation for associating the first history log collected from the terminal device 102 with the second history log in the distribution center 101 so as to use them will be explained using the flow chart shown in FIG. 26.

The history log sending and receiving unit 1311 in the right management server 101e acquires the first history log or the second history log corresponding to the content from the right management server 101b or the content distribution server 101c (step S2601). More specifically, the history log sending and receiving unit 1311 acquires the first history log from the right management server 101b as to the content and acquires the second history log from the content distribution server 10c. However, in the case of a streaming content, the second history log may be sent to the history log management server 101e immediately after receiving it from the terminal device 102, but the way of receiving history logs is not limited to simultaneously receiving the first history log and the second history log.

The history log analyzing unit 1313 judges whether all the history logs to the corresponding content have already been acquired or not (step S2602). More specifically, the history log analyzing unit 1313 judges whether all users' first history logs and second history logs of the corresponding content have already been received or not from the history log sending and receiving unit 1311.

When the answer of the step S2602 is NO, that is, when all the history logs have not confirmed yet, step S2603 is executed.

When the answer of the step S2602 is YES, that is, when all the history logs have already been confirmed, this processing finishes.

The history log analyzing unit 1313 verifies the first and the second history logs (step S2603). More specifically, the history log analyzing unit 1313 confirms the authenticity of the second history logs by verifying the descriptions of the first history logs that is securely acquired and the descriptions of the second history logs. More specifically, the history log analyzing unit 1313 compares content IDs of the first history logs from the right management server 101b with the content IDs of the second history logs from the content distribution server 101c (S3a), compares user IDs, operation descriptions and operation time of the first history logs with those of the second history logs in the same way (S3b to S3d), and judges whether all of the comparison results match or not (S3e). A permissible difference may be regarded as substantially the same in this judgment. Further, when the comparison results are judged to be matched, the history log analyzing unit 1313 generates verification information indicating the fact for each content ID (S3f), while it generates the error information indicating matched items and unmatched items as a comparison result in detail for each content ID when the comparison results are judged to be not matched (S3g). As a result, when verification information is generated, it is verified that the first history logs and the second history logs of the terminal IDs have sufficient authenticity. In contrast, when error information is generated, it is concluded that the first history logs and the second history logs about the content do not have sufficient authenticity but have low authenticity according to the ratio of the matched items to the unmatched items or do not have any authenticity.

For example, in FIG. 12, the terminal “TERMINAL-ID-00001” shows that the time of starting receiving a stream, that is, the time when starting playing back a content at 10:00:00 in December 24th of 2002 by referring to the RR receiving time 1206. On the other hand, in the first history logs of a secure history logs shown in FIG. 7, referring to the first history log 704 makes it possible to indicate that the terminal ID “TERMINAL-ID-00001” (the user “USER-ID-00001”) started playing back at 10:00:00, in December 24 of 2002. Therefore, the authenticity of the operation time of the nonsecure second history log is proved by the secure first history log.

Here, when it is judged that the first history logs do not match the second history logs because the degree of errors is not permissible the authenticity of the second history logs is not confirmed, and the verification fails. For example, providing that the playback starting time of the content shown in the second history log is “2003.1.1 00:00:00”, when the secure first history log is “2003.1.3 12:42:13” and no first history log is included, it is possible to judge whether the first history logs do not match the second history logs.

Conceivable causes of the incongruity of the first history logs and the second history logs are listed as follows: a packet missing by a deluge of a network, a manipulation by a user, an operational mistake by a user, a break down of the terminal device 102 and the like. In this case, storing error information whose verification failed and verification information makes it possible to use these causes for verification.

The history log analyzing unit 1313 stores the first and the second history logs whose verifications have been already finished and store them in the history log DB 1301 (step S2604). As a result of verifying the first history logs and the second history logs in step S2603, when it is judged that the authentication of the second history logs is low, it is possible not to store the history log DB 1301. The history logs stored in the history log DB 1301 may be part or all of the first and the second history logs. Also, the history log analyzing unit 1313 processes the first and the second history logs (for example, integrates the first history logs with the second history logs, extracting only particular information or the common information and the like) and then stores the processed history logs instead of storing the history logs as they are. After that, step S2602 is executed.

An explanation on sequential processing performed in the terminal device has already been finished up to this point, the processing is as follows: a user acquires an LT 800 from the right management server 101b and uses the content securely, records the first history logs according to the use status, records the receiving status of the content (stream) as the second history logs, sends the first history logs from the terminal device 102 to the right management server 101b, sends the second history logs from the terminal device 102 to the content distribution server 10c, associates the first history logs with the second history logs in the distribution center 101, and uses them.

By the way, as another use method for associating the first history logs with the second history logs in the distribution center 101, a method of changing the use condition owned by the user according to the result of the stream receiving status in the terminal device 102 is conceivable.

More specifically, the following service in the streaming content is an example: a packet receiving rate showing that a user received packets normally by using the second history logs after verifying the first history logs and the second history logs in the streaming content, the user whose packet receiving rate is under the threshold managed in the distribution center 101 is not allowed to subtract the user use conditions but add the user use conditions managed in the right management server 101b of the distribution center 101. Of course, with a viewpoint of giving a user a guarantee according to the packet receiving rate, it is possible to send an LT 800 to the terminal device 102 directly or use a method of giving a user a cash back by associating with the charging server 101a instead of adding the use condition of the right management server 101b.

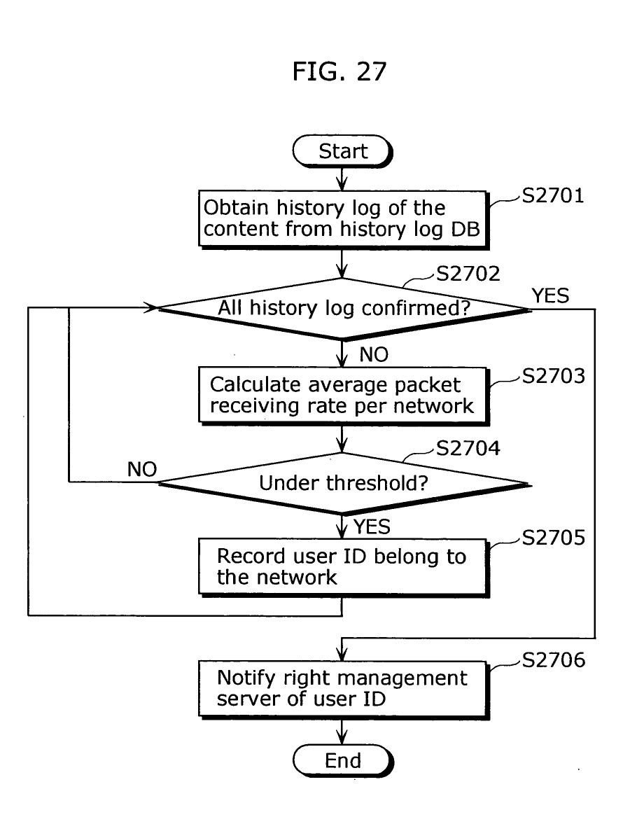

This service will be explained with reference to flow charts and figures in FIGS. 27 to 29. An example case where this service is applied to the streaming type contents will be explained below.

The history log analyzing unit 1313 of the history log management server 101e acquires history logs of the contents from the history log DB 1301 (step S2701). More specifically, the history log analyzing unit 1313 reads out all users' history logs of the contents from the history log DB 1301 (step S2701) using the content ID of the content as a key.

The history log analyzing unit 1313 judges whether all history logs have already been confirmed or not (step S2702).

When the answer of the step S2702 is NO, when all the history logs have not been confirmed yet, step S2703 is executed.

When the answer of the step S2702 is NO, when all the history logs have already been confirmed, step S2706 is executed.

The history log analyzing unit 1313 calculates average packet receiving rates for each network to which the terminal device 102 belong (step S2703). More specifically, the history log analyzing unit 1313 refers to the history log management table 1400 shown in FIG. 14, searches the history log 1404 of the terminal device 102 whose network address matches based on the IP address of the terminal device 102 shown in the terminal information 1402 and calculates the packet receiving rates for each network.

For example, as the IP address of the terminal device 102 “TERMINAL-ID-00001” of a user whose user ID 1401 is “USER-ID-00001” in the history log management table 1400 shown in FIG. 14 is “202. 192. 39. 3” (the IP address of class C), the network address is “202. 192. 39. 0” and the terminal device 102 that belongs to this network is searched from the history log management table 1400.

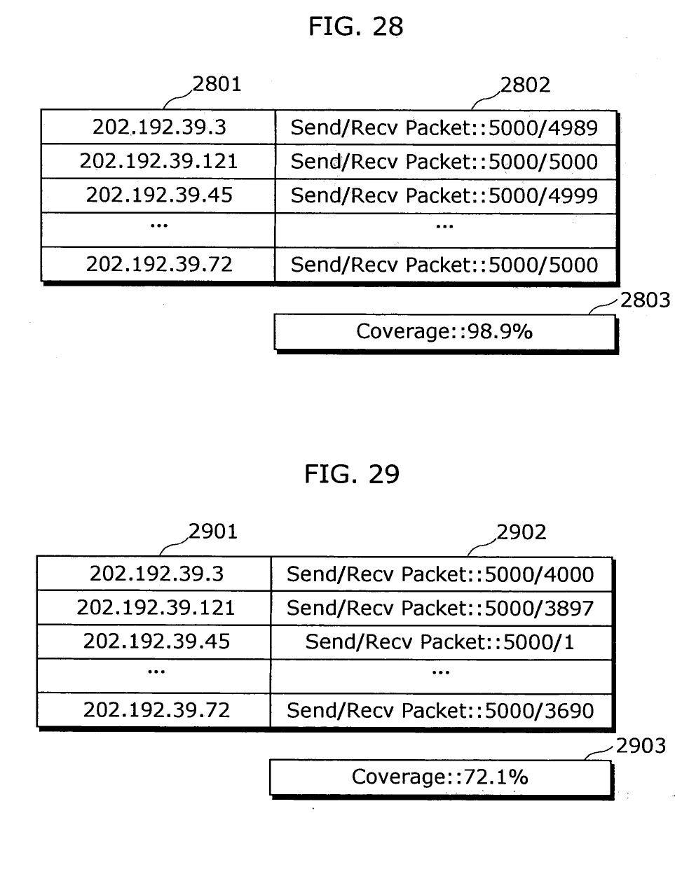

The figure shown in FIG. 28 is an example of the calculation result of the packet receiving rate. FIG. 28 shows a packet receiving rate 2802 to the IP address 2801 of the terminal device 102 and the average value of the packet receiving rate 2802 of the terminal device 102 that belongs to this network is shown in the average packet receiving rate 2803. An example case where the average packet receiving rate 2803 is calculated to be 98.8% is shown in FIG. 28. Likewise, an example case where the average packet receiving rate 2903 is calculated to be 72.1% is shown in FIG. 29.

The history log analyzing unit 1313 judges whether the average packet receiving rate calculated in step S2703 is under the threshold or not (step S2704). More specifically, the history log analyzing unit 1313 compares the threshold preset in the history log management server 101e as to the content with the average packet receiving rate calculated in step S2703 and judges whether the average packet receiving rate is under the threshold or not.

When the answer of the step S2704 is YES, that is, when the average packet receiving rate is under the threshold, step S2705 is executed. For example, providing that the threshold preset in the history log management server 101e is 90% as to the content, as the average packet receiving rate 2903 is 72.1% in the example shown in FIG. 29, the average packet receiving rate is judged to be under the threshold.

When the answer of the step S2704 is NO, that is, when the average packet receiving rate is not less than the threshold, step S2702 is executed. For example, providing that the threshold preset in the history log management server 101e is 90% as to the content, as the average packet receiving rate 2803 is 98.9% in the example shown in FIG. 28, the average packet receiving rate is judged to be not less than the threshold.

The history log analyzing unit 1313 stores the user ID of a user who owns the terminal device 102 whose average packet receiving rate is under the threshold (step S2705). More specifically, as the history log analyzing unit 1313 records the user ID who owns the terminal device 102 which belongs to the network whose average packet receiving rate is judged to be under the threshold in the step S2704, it identifies the terminal device 102 which belongs to the network whose average packet receiving rate is judged to be under the threshold from the terminal information 1402 by referring to the history log management table 1400 and acquires the user ID 1401 who owns the terminal device 102.

The history log analyzing unit 1313 notifies the right management server 101b of the user ID (step S2706). More specifically, the history log analyzing unit 1313 notifies the right management server 101b of the user ID so as to add the use conditions of the content owned by the user ID recorded in the step S2705. After that, step S2702 is executed. Meanwhile, the right management server 101b adds the use conditions of the content ID owned by the user ID who is notified by the history log management server 101e.

An explanation on processing has already been finished up to this point, the processing is for updating use conditions owned by a user according to the stream receiving status in the terminal device 102 by associating the first history logs with the second history logs in the distribution center 101.

Here, as to a method for calculating the average packet receiving rate, an example case where an average packet receiving rate is calculated for each network to which the terminal device 102 belongs, but the calculation method is not limited to this, which means that it is possible to calculate the average packet receiving rate based on various kinds of standards such as physical or logical location relationship of the terminal device 102. Also, here, the threshold that is used for judging an average packet receiving rate in the step S2704 is managed in the history log management server 101e in step S2704, but it may be managed in another server device of the distribution center 101.

Also, an example case where an average packet receiving rate is calculated in the distribution center 101 is shown here, but it may be calculated in the terminal device 102. For example, a threshold for comparing an average packet receiving rate is previously sent from the distribution center 101 to the terminal device 102 by using the LT 800 or the like, when the average packet receiving rate in the terminal device 102 is under the threshold received from the distribution center 101 as a result of using the content, the LT 800 is returned to the distribution center 101.

It is possible to determine whether the user use condition should be changed or not based on the response rate of the LT 800 of the terminal device 102 which is belonged to the same network as the terminal device 102 to which the LT 800 is returned. Further, in this case, when it is under the threshold, it is possible to send the LT 800 for reviewing the content to the terminal device 102 instead of updating the use condition of the right management server 101b. Also, it is possible to schedule a program for broadcasting the content again.

Also, an example case where the number of packets (data amount) received by the terminal device 102 is guaranteed here, a case where content quality (image quality, sound quality, sound channel or the like) is guaranteed is also conceivable. In this case, a codec needs to be able to code the hierarchically coded content. Further, it is possible to detect the quality of the content using either a secure method or a nonsecure method in the content use unit 1520 of the terminal device 102.

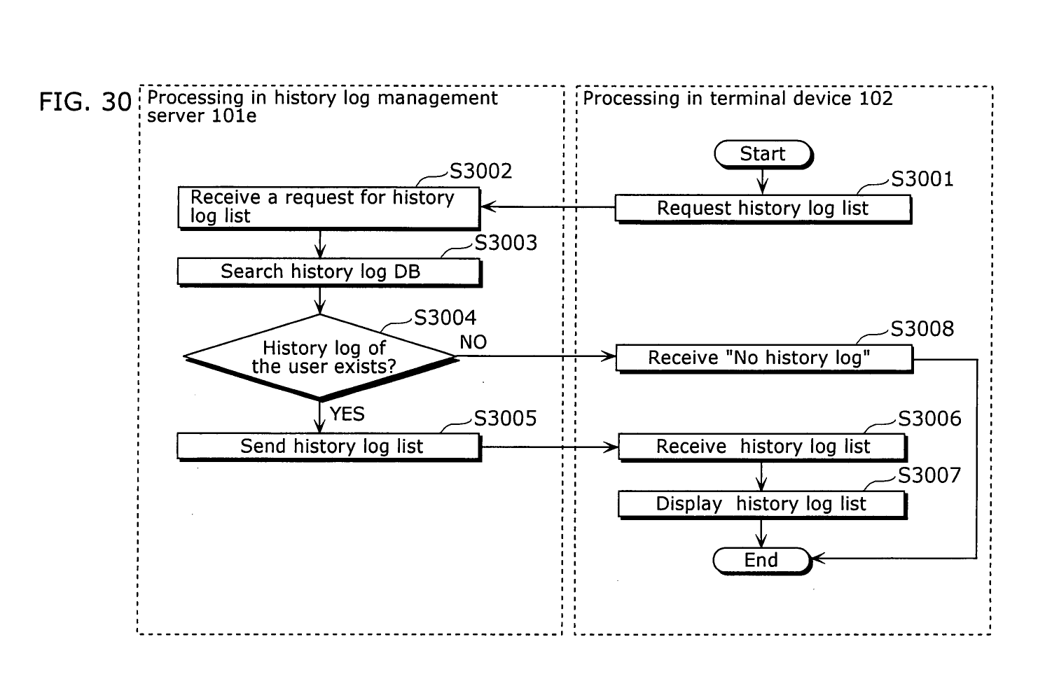

Also, as a use method of the other history logs provided by the history log management server 101e, providing the history logs that are acquired from the first and the second history logs in the history log management server 101e and stored in the history log DB 1301 in the content history log collecting system 1 to the user (terminal device 102) makes it possible to use the history logs of the content as a remainder. This processing will be explained using a flow chart shown in FIG. 30.

A user requests for a list of the history logs such as the contents which are used by the user in the past to the history log management server 101e via the browser 1551 of the terminal application 1550 of the terminal device (step S3001). More specifically, the user accesses the history log management server 101e using the browser 1551 and sends the user ID of the user to the history log management server 101e. At this time, it is possible to perform inter-authentication with the history log management server 101e using an SSL or a TSL.

The history log request receiving unit 1312 of the history log management server 101e receives a list request of the history logs from the terminal device 102 (step S3002). More specifically, the history log request receiving unit 1312 receives a message for requesting the acquirement of the history log list as to the user ID including the user ID.

The history log analyzing unit 1313 searches user history logs for requesting a history log list from the history log DB 1301 (step S3003). More specifically, the history log analyzing unit 1313 acquires the user ID of the user who requests a history log list from the history log request receiving unit 1312 and searches the history log management table 1400 of the history log DB 1301 using the user ID as a key.

The history log analyzing unit 1313 judges whether history logs of the user is included in the history log DB 1301 or not (step S3004). More specifically, the history log analyzing unit 1313 judges whether the history log of the user who has the user ID is searched or not from the search result of the history log DB 1301.

When the answer of the step S3004 is YES, that is, when the history logs of the user is included, step S3005 is executed.

When the answer of the step S3004 is NO, that is, when the history logs of the user is not included, generates a message showing “No history log” and sends it to the terminal device 102. After that the terminal device 102 executes step S3008.

The history log analyzing unit 1313 sends the acquired user history logs to the terminal device 102 (step S3005). More specifically, the history log analyzing unit 1313 transforms the history logs of the user acquired by executing the step S3004 into HTML, XML or the like as necessary, extracts only necessary information items and uses the result as the history log list when sending it to the terminal device 102.

The browser 1551 of the terminal device 102 acquires the history log list from the history log management server 101e (step S3006) and displays it on a monitor (step S3007).

Also, when the answer of the step S3004 is judged to be NO, the browser 1551 of the terminal device 102 receives the message of “No history log” from the history log management server 101e (step S3008), presents the fact to the user via the browser 1551 so as to finish this processing.

The processing for providing the history log managed in the history log management server 101e will be explained to the user.

All history logs concerning the user who has a user ID are requested here, but only specified history logs may be requested. For example, it is possible to request for history logs concerning the specified content of the user who has a user ID by sending the user ID and the content ID to the history log management server 101e.

Also, it is possible to provide other users with history logs as necessary after getting the user's permission in addition to providing the user's history logs. By doing so, it is possible to introduce other users to the content.

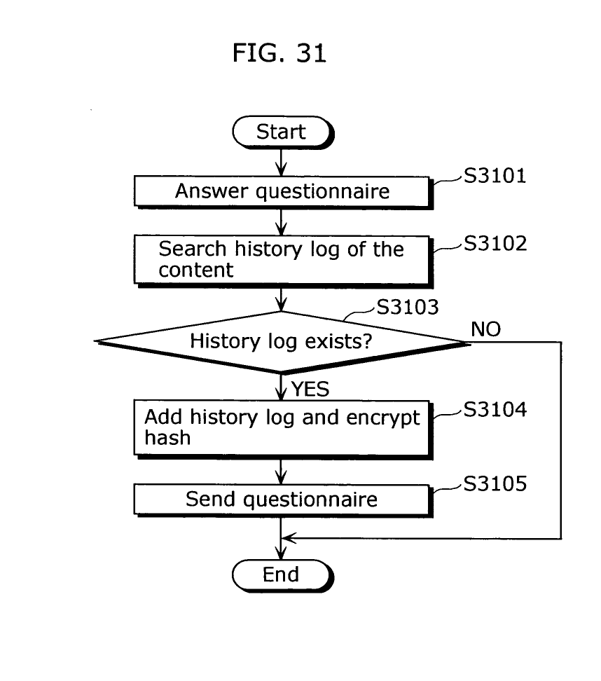

Also, it is possible to send the first and the second history logs together in the terminal device 102. Here is an example case where secure second history logs are added in the terminal device 102 in the questionnaire on the web provided by the web server 101d of the distribution center 101 and the authenticity of the questionnaire is improved. The processing concerning this example case will be explained using a flow chart shown in FIG. 31.

The web server 101d of the distribution center 101 provides the terminal device 102 with a questionnaire for obtaining users' view on a program using HTML or the like. A content ID for identifying the program (content) is assigned to this questionnaire. The browser 1551 of the terminal device 102 downloads the web page of the questionnaire from the web server 101d and answers the questionnaire using a keyboard or an input unit such as a remote controller which is not shown in FIG. 15 (step S3101). The questionnaire is sent as the second history logs from the browser 1551 to the third history log acquirement unit 1553. Further, it is sent to the first history log acquirement unit 1505.

The first history log acquirement unit 1505 searches the first history logs concerning the content from the secure DB 1504 (step S3102). More specifically, as the first history log acquirement unit 1505 can acquire the questionnaire and the content ID of the program via the third history log record unit 1552 from the browser 1551, it searches the secure DB 1504 using the content ID as the key.

The first history log acquirement unit 1505 judges whether the first history logs of the program is included or not (step S3103).

When the answer of the step S3103 is YES, that is, when the first history logs of the program is included, step S3104 is executed.

When the answer of the step S3103 is NO, that is, when the first history log of the program is not included, as the first history logs which corroborates the authenticity of the questionnaire is not included, the fact is presented to the user and this processing is finished without sending the questionnaire to the distribution center 101. Here, it is also possible to confirm the authenticity of the questionnaire after sending the questionnaire to the distribution center 101 irrespective of the presence or absence of the first history logs and confirming the presence or absence of the first history logs and the descriptions in the distribution center 101.

The first history log acquirement unit 1505 acquires the first history logs of the program and adds them to the questionnaire (step S3104). More specifically, the first history log acquirement unit 1505 acquires the first history logs from the secure DB 1504, adds them to the questionnaire, calculates the hash value of the questionnaire and the first history logs using a hash algorithm such as SHA-1 and encrypts them using an encryption key which is commonly used between the distribution center 101 and the terminal device 102. The first history log acquirement unit 1505 sends the questionnaire generated in this way to the browser 1551 via the third history log acquirement unit 1553 together with the hash value.

The browser 1551 sends the questionnaire to which the first history logs acquired from the first history log acquirement unit 1505 are added to the distribution center 101 via the network 103 (step S3105). The distribution center 101 can judge whether a user answers the questionnaire after viewed the program or not by receiving this questionnaire, confirming the hash value added in the step S3104 and the first history logs.

Note that it is possible to judge the authenticity of the questionnaire according to the tendency (such as use tendency for each genre or the like) of history logs managed by the history log management server 101e when the questionnaire is the one concerning the user's favorites, while an example case of the questionnaire concerning the view of the user who used a content is shown here. Also, it is possible to store the first and the second history logs in the terminal device 102 so as to judge whether the questionnaire is sent or not based on these history logs.

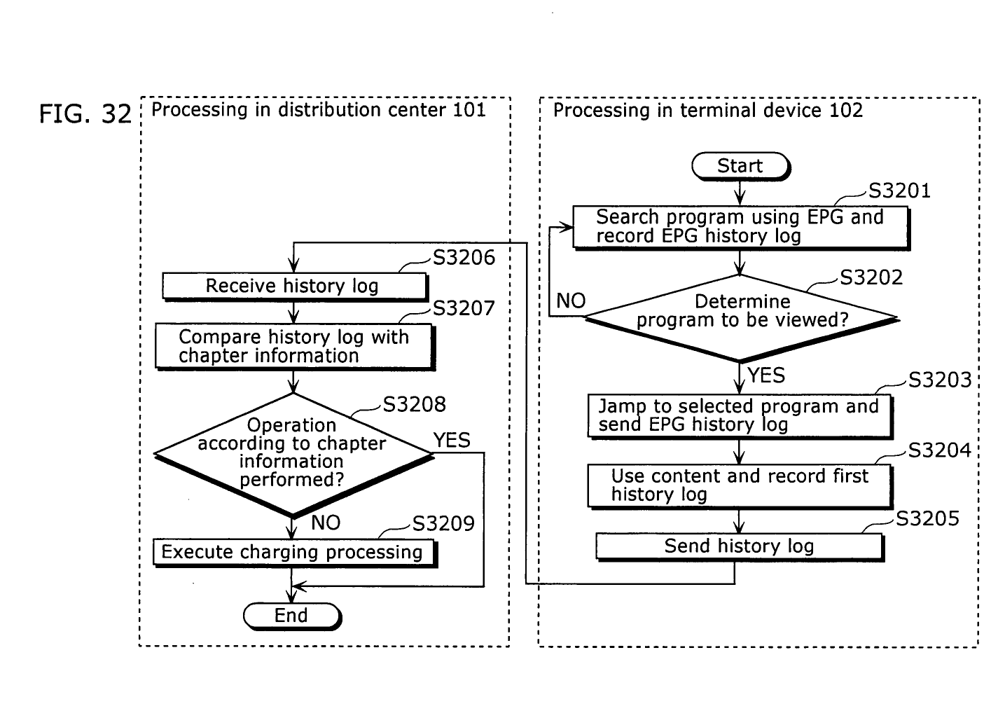

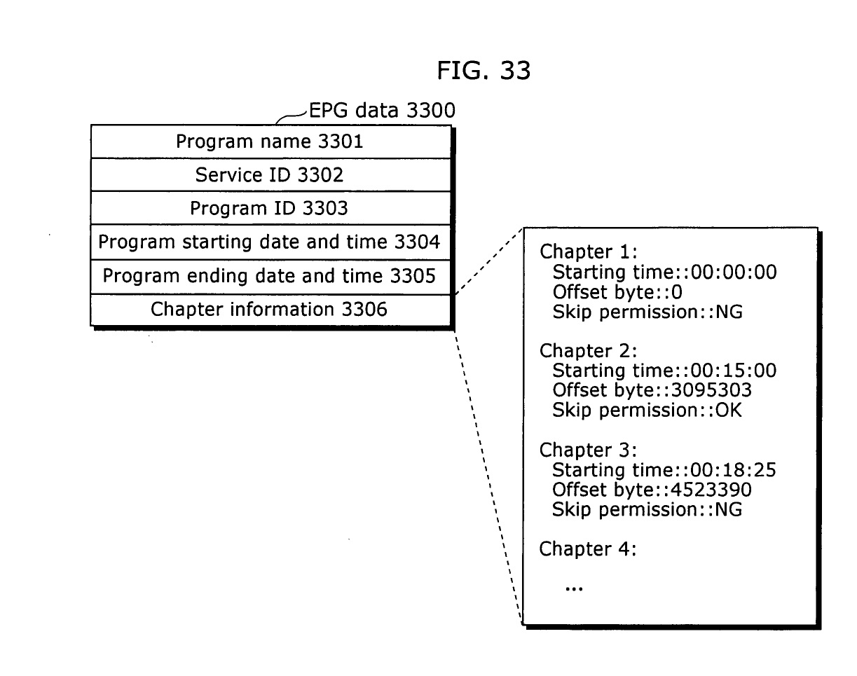

Next, as the other examples, an example case where a user searches a program on a broadband network/broadcasting using an EPG, uses data concerning the program included in the EPG and views the program on the broadband network/broadcasting will be explained with reference to FIGS. 32 and 33. In this service, it is possible to skip a chapter or the like by using the chapter information of the program included in the EPG.

FIG. 32 is a flow chart showing the following processing: a user searching a program using the EPG makes the terminal device 102 acquire history logs of the EPG as the second history logs different from the first history logs and send the second history logs together with the first history logs to the distribution center 101.

The user refers to the EPG using the browser 1551 and searches the program desired by the user (step S3201). More specifically, the browser 1551 acquires the EPG data from the Internet, analyzes the EPG data in the EPG control unit 1552 and presents the data to the user via the browser 1551, which enables the user to use the EPG. Also, the EPG control unit 1552 records the history logs of the EPG operated by the user (written as the EPG history logs from here) as the second history logs and sends them to the third history log acquirement unit 1553.

FIG. 33 is an example of the EPG data used by the terminal device 102. The EPG data 3300 comprises a program name 3301 where the program name is written in text data, a service ID 3302 for identifying the broadcasting station (service provider) for broadcasting the program using the broadband or the like, a program ID 3303 (content ID) for identifying the program in the service ID 3302, a program starting date and time 3304 for showing the program starting date and time, a program finishing data and time 3305 for showing the program finishing date and time and a chapter information 3306 for searching the chapter in the program.

The chapter information 3306 includes starting time showing the relative time from the program starting date and time 3304, an offset byte showing the relative byte size from the start of the program, a skip permission showing whether the chapter should be skipped or not for each chapter. For example, as the chapter 1 is located in the head of the program, the starting time is “00:00:00”, the offset byte is “0”, and the skip ID is “NG”, which shows that skipping is not permitted. In contrast, in the case of the chapter 2, it starts from the time when “00:15:00” minutes after the starting time of the program, the offset byte from the head of the program in the chapter 2 is “3095303”, which shows that skipping is “OK”.

Note that the EPG data 3300 and the chapter information 3306 can be realized in a script language (text data) such as XML or MPEG-7 or binary data.

The EPG control unit 1552 judges whether the user has already determined the desired program or not (step S3202).

When the answer of the step S3202 is YES, that is, when the user has already determined the desired program, step S3203 is executed.

When the answer of the step S3202 is NO, that is, when the user has not determined the desired program yet, step S3201 is executed.

The EPG control unit 1552 instructs the content control unit 1520 to jump to the program selected by the user (step S3203). More specifically, the EPG control unit 1552 requests the content use unit 1520 to display the program on a monitor which is not shown in FIG. 15 or the like by sending the data such as a service ID 3302, a program ID 3303 or the like to the link destination. At the same time, it makes it possible to include the first and the second history logs in an LT and send it to the right management server 101b by sending the EPG history logs to the first history log acquirement unit 1505.

The content use unit 1520 uses the link destination program (step S3204). More specifically, the content use unit 1521 of the content use unit 1520 acquires a service ID 3302, a link destination URI or the like from the program ID 3303 and acquires the program data from the content distribution server 10c. As the processing in the step S3204 is the same as the processing shown in FIGS. 22 and 23, its explanation is omitted here. The operation for performing program skipping using the chapter information 3306 of the EPG data 3300 will be explained below.

As a starting time and an offset byte of each chapter are written in the chapter information 3306, sending this information to the content distribution server 101c makes it possible to request for user's favorite chapter. The content distribution server 101c reads out the data of the program from the content DB 1011 according to the chapter information received from the terminal device 102 and sends the program to the terminal device 102 according to the processing shown in FIG. 24. For example, when a user desires to watch the content from the chapter 3 while watching the content, the terminal device 102 acquires the relative starting time (“00:18:25”) from the content head of the chapter 3 or the offset byte (4523390) from the content head by referring to the chapter information 3306 in FIG. 33 and sends them to the content distribution server 101c.

The content distribution server 101c searches the head of the chapter 3 using the relative starting time of the content head or the offset byte from the content head received from the terminal device 102 and sends the data from the head of the chapter 3 using the RTP. Note that it is possible to make the content distribution server 101c hold the metadata of the chapter starting location or the like and make the terminal device 102 specify the chapter number or the like, while the relative starting time from the content head and the offset byte from the content head are sent from the terminal device 102 to the content distribution server 101c here.

When a user finishes viewing the program, the first history log acquirement unit 1505 securely sends, to the right management server 101b (step S3205) the first history logs acquired from the content use control unit 1503 and the content use unit 1521 and the EPG history logs as the second history logs acquired in the third history log acquirement 1553.

The distribution center 101 receives the first history logs including the second history logs from the terminal device 102 (step S3206). More specifically, the right management server 101b of the distribution center 101 receives the first history logs including the second history logs sent from the terminal device 102 and sends them to the history log management server 101e. The history log management server 101e receives the first history logs and the EPG history logs (the second history logs) via the LAN 101n and stores them in the history log DB 1301. Note that it is possible to verify and store the first and the second history logs in the history log DB 1301.

The history log management server 101e compares history logs of the content acquired from the terminal device 102 with the chapter information 3306 of the EPG data 3300 (step S3207). More specifically, the history log analyzing unit 1313 of the history log management server 101e acquires the history log 1404 of the program from the history log management table 1400 of the history log DB 1301 and refers to the detailed and secure user operation descriptions (Play, Fwd, Pause and the like) of the history log 1404. Further, it acquires the EPG data 3300 concerning the chapter of the program from the server device that provides the EPG data 3300 such as the content distribution server 101c or the EPG server which is not shown in FIG. 1 and compares the history log 1404 with the EPG data 3300.

The history log analyzing unit 1313 confirms whether or not the descriptions registered in the history log 1404 shows the operation performed according to the skip permission in the chapter information 3306 of the EPG data 3300 (step 53208). More specifically, it confirms whether the chapter without any skip permission is skipped or not by referring to the packet receiving rate of the RTP packet which received the time when special playback is performed or the program data. This is because it is not guaranteed that the EPG data 3300 and the user operation using the EPG data 3300 is secure and because it is possible to permit a user to skip a chapter by paying surcharge after notifying the user of the processing even where skipping the chapter of the program is prohibited and skip the chapter as user's request.

When the answer of the step S3208 is NO, that is, when a user does not perform the operation according to the chapter information, charging processing is performed and the step S3209 is executed.

When the answer of the step 53208 is YES, that is, when a user performs the operation according to the chapter information, this processing finishes.

The history log analyzing unit 1313 performs charging processing in the charging server 101a by notifying the charging server 101a of the information and the like on the user ID, the content ID and the skipped chapter (step S3209).

In this way, in the content history log collecting system 1, collating user operation record (the second history logs) concerning the EPG with secure history logs (the first history logs) makes it possible to improve the authenticity of the history logs showing which EPG a user referred to so as to watch the program and the like and provide the service provider and the like with the data useful for marketing and the like. Also, paying surcharge makes it possible to provide users with a user operation service other than operations prescribed in the EPG data 3300.

A discount service according to the data amount after skipping a chapter based on the EPG data 3300 is also conceivable, while an example case of charging a user for a user operation other than operations prescribed in the EPG data 3300. In other words, it is the service of discounting the viewing rate of the program when the view time is shorter than the actual program time (data amount).

Also, a service for allowing only users who watched a content to watch the following related content can be realized. For example, when considering a series program of 10 stories in total, sending the user ID of a user whose history log concerning the first story included in the history logs managed by the history log management server 101e to the right management server 101b enables the right management server 101b to assign the user a use condition for viewing the second story.

Also, an example case where the information on a user operation as history logs of the EPG is shown here, in addition to this, it is possible to record information such as the type of EPG used by a user (digital broadcasting EPG, internet EPG or the like), the function of EPG (a recording reservation function, a function for linking between digital broadcasting program and internet broadcasting program or the like.

Up to this point, in the content history log collecting system 1, associating the history logs collected by a plurality of methods with each other in the distribution center 101 or the terminal device 102 makes it possible to provide a service provider or a user with various kinds of secure history logs.

Note that an example case of having three history log acquirement units, that is, a single unit (the first history log acquirement unit 1505) operable to acquire the first history logs and two units (the second history log acquirement unit 1523 and the third history log acquirement unit 1553) operable to acquire the second history logs in the terminal device 102 is shown in the embodiment of the present invention, but the construction is not limited to this, which means that it is possible to have units operable to acquire at least one unit operable to acquire the first history logs and at least one unit operable to acquire the second history logs.

Also, as example methods for associating the first history logs with the second history logs, a method for associating them with each other indirectly using a terminal ID stored in the secure DB 1504 and a method for associating the first history logs and the second history logs directly or indirectly in the first history log acquirement unit 1505 in the embodiment of the present invention, but the method is not limited to this, which means that it is possible to use another method as long as the method is for associating the first history logs and the second history logs directly or indirectly. For example, it is possible to associate the first history logs with the second history logs by another ID (a user ID or the like) identifiable in the content history log collecting system 1.

Also, an example case where a distribution center 101 is composed of a plurality of server devices in the embodiment of the present invention, but the construction of the distribution center 101 is not limited to this, for example, it is possible to construct it in a way that a plurality of functions are realized in a single server.

Also, an example case where the first history logs collected in the content use unit 1521 in the terminal device 102 is acquired by the first history log acquirement unit 1505 in the embodiment of the present invention, but the unit is not limited to this, another secure unit in the content use unit 1520 different from the first history log acquirement unit 1505 can also be set.

Also, an example case where the RR 1100 of the RTCP is used as the second history logs in the embodiment of the present invention, it is possible to use a stream request (PLAY) by the RTSP or a request by the HTTP can also be used as the second history logs.

Also, setting a unit operable to control the second history log collection in the distribution center 101 and sending the control information for controlling the second history log collection from the distribution center 101 to the terminal device 102 enables the terminal device 102 to collect the second history logs according to the control information in the embodiment of the present invention.

Also, an example case where the second history logs are nonsecurely acquired and sent from the terminal device 102 to the distribution center 101 in the embodiment of the present invention, the acquirement and sending methods are not limited to these mentioned earlier, it is conceivable that history logs useful for a service provider or a user can be acquired by associating with other secure history logs different from the first history logs. In other words, it does not matter whether a history log is secure or not when it is possible to provide a user with information useful for a service provider or the user by complementarily associating a plurality of history logs with each other.

Also, an example case where the history log response condition 913 shown in FIG. 9 is a condition used by only the right management unit 1500 in the embodiment of the present invention, but a condition is not limited to this, it is also possible to set a condition used by the content use unit 1520.

Also, the first history logs are set in an LT 800 and sent from the terminal device 102 to the distribution center 101 in the embodiment of the present invention, but the processing is not limited to this, it is possible to send the first history logs from the terminal device 102 to the distribution center 101 by using the data construction other than the LT 800 associating with the timing for sending the LT 800 from the terminal device 102 to the distribution center 101.

Also, an example of improving the authenticity of the second history logs using the first history logs or an example of storing the information obtained in the first history logs using the second history logs are shown in the embodiment of the present invention, but there is no need to always perform the above-mentioned processing on all history logs, in other words, it may be performed as necessary, for example, when grasping the tendency of a history log or checking it without any notice.

Also, an example case where history logs are collected for each terminal device 102 in the embodiment of the present invention, but, for example, it is possible to collect history logs for each home server or each channel server in a logical or physical network such as a home network.

Also, in addition to the history logs shown in the embodiment of the present invention, it is possible to record the following data as history logs: history logs on charging (the method of payment, the target of payment, the amount of payment and the like), history logs on device control (the frequency of using the device, the use condition of the device, the backup status of the device, the infrastructure load and the like), history logs of the various kinds of data management (contents, licenses and the like), history logs of the second use of the content and history logs of the request for a program (content) by a user.

Also, as another use method of the history logs in the distribution center 101, it is possible to assess the repeater rate by obtaining the correlation between programs or between a program and a CM or the like based on the history logs collected from the terminal device 102. Also, it is possible to abolish use conditions of the contents which are unpopular among users based on the history logs collected from the terminal device 102 in the distribution center 101. Also, it is possible to use them as grounds for distributing profits to the copyright holder of the program data, as grounds for user claims or information for user supports.

Further, an example case where contents, licenses, value information and the like are fetched from a single distribution path in the embodiment of the present invention, but it is also possible to fetch them from a multiplexed distribution path concurrently using digital broadcasting and the Internet or a package medium and the Internet.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A system comprising a server device that provides a license and a terminal device that controls content use based on a license provided from the server device,
wherein the server device includes:
a first collecting unit operable to collect first history logs concerning the content use sent from the terminal device;
a second collecting unit operable to collect the second history logs concerning the content use sent from the terminal device separately from the collection by the first collection unit; and
a verifying unit operable to verify the first history logs collected by the first collecting unit and the second history logs collected by the second collecting unit; and
the terminal device includes:
a first acquirement unit operable to acquire the first history logs concerning the content use;
a second acquirement unit operable to acquire the second history logs concerning the content use; and
a history log sending unit operable to separately send the first history logs acquired by the first acquirement unit and the second history logs acquired by the second acquirement unit.

2. The system according to claim 1,
wherein the first acquirement unit securely acquires the first history logs, and the history log sending unit securely sends the first history logs.

3. The system according to claim 2,
wherein the second acquirement unit nonsecurely acquires the second history logs, and the history log sending unit nonsecurely acquires the second history logs.

4. The system according to claim 1,
wherein the first and the second history logs include at least one of a terminal ID, a content ID, a user ID, a description of user operation concerning the content use and user operation time respectively, and
the verifying unit verifies that the first history logs are substantially the same as the second history logs by comparing them with each other.

5. The system according to claim 4,
wherein the server device further includes a storage unit operable to store one of (a) at least one of the first history logs and the second history logs and (b) history logs generated based on (a) in a history log database unit according to the verification result by the verifying unit.

6. The system according to claim 5,
the verifying unit generates comparison information showing the comparison result when the comparison result is not substantially the same.

7. The system according to claim 6,
wherein the server device further includes:
a database unit operable to store the collection conditions concerning the history logs to be collected in the terminal device;
a generation unit operable to dynamically generate indication information indicating a request that the terminal device collect the history logs according to the collection condition stored in the database unit; and
an indication information sending unit operable to send the generated indication information to the terminal device; and
the first acquirement unit acquires the first history logs according to the indication information sent from the server device.

8. The system according to claim 7,
wherein the collection condition relates to a combination of two or more data selected from content use date and time, a use part of whole played-back part of a content, a description of user operation for using a content, a user profile, user's terminal device ID, user's use status, a content use status and a content service providing status.

9. The system according to claim 8,
wherein the server device further includes:
a use condition database unit operable to store content use conditions for each user of the terminal device; and
a license issuing unit operable to issue a license for permitting a user to use a content to the terminal device according to the use condition of a user stored in the use condition database unit; and
the terminal device further includes:
a content use unit operable to use a content according to the issued license; and
the indication information sending unit operable to send the license with the indication information.

10. A server device providing a terminal device that uses a content with a content, including:
a first collecting unit operable to collect first history logs concerning the content use sent from the terminal device;
a second collecting unit operable to collect the second history logs concerning the content use sent from the terminal device separately from the collection by the first collection unit; and
a verifying unit operable to verify the first history logs collected by the first collecting unit and the second history logs collected by the second collecting unit.

11. The server device according to claim 10,
wherein the first collecting unit securely collects the first history logs from the terminal device.

12. The system according to claim 11,
wherein the second collecting unit nonsecurely collects the second history logs.

13. The server device according to claim 10,
wherein the first and the second history logs include at least one of a terminal ID, a content ID, a user ID, a description of user operation concerning content use and user operation time respectively, and
the verifying unit verifies that the first history logs are substantially the same as the second history logs by comparing them with each other.

14. The server device according to claim 13,
wherein the server device further includes a storage unit operable to store one of (a) at least one of the first history logs and the second history logs and (b) history logs generated based on (a) in the history log database unit according to the verification result by the verifying unit.

15. The server device according to claim 14,
wherein the verifying unit generates comparison information showing the comparison result when the comparison result is not substantially the same.

16. The server device according to claim 15,
wherein the server device further includes:
a database unit operable to store the collection conditions concerning the history logs to be collected in the terminal device;
a generation unit operable to dynamically generate indication information indicating a request that the terminal device collect the history logs according to the collection condition stored in the database unit; and
an indication information sending unit operable to send the generated indication information to the terminal device.

17. The server device according to claim 16,
wherein the collection condition relates to a combination of at least two or more data selected from content use date and time, a use part of whole played-back part of a content, a description of user operation for using a content, a user profile, user's terminal device ID, user's use status, a content use status and a content service providing status.

18. The server device according to claim 17,
wherein the server device further includes:
a use condition database unit operable to store content use conditions for each user of the terminal device; and
a license issuing unit operable to issue a license for permitting a user to use a content to the terminal device according to the use condition of a user stored in the use condition database unit; and
the terminal device further includes:
a content use unit operable to use a content according to the issued license; and
the indication information sending unit operable to send the license with the indication information.

19. A terminal device for using a content including:
a first acquirement unit operable to acquire first history logs concerning the content use;
a second acquirement unit operable to acquire second history logs concerning the content use; and
a history log sending unit operable to separately send the first history logs acquired in the first acquirement unit and the second history logs acquired in the second acquirement unit to the server device.

20. The terminal device according to claim 19,
wherein the first acquirement unit securely acquires the first history logs, and the history log sending unit securely sends the first history logs.

21. The terminal device according to claim 20,
wherein the second acquirement unit nonsecurely acquires the second history logs, and the history log sending unit nonsecurely acquires the second history logs.

22. The terminal device according to claim 19,
wherein the first and the second history logs include at least one of a terminal ID, a content ID, a user ID, a description of user operation concerning the content use and user operation time respectively.

23. The terminal device according to claim 22,
wherein the first acquirement unit acquires the first history logs according to the indication information sent from the server device, and
the indication information relates to a combination of two or more data selected from content use date and time, a use part of whole played-back part of a content, a description of user operation for using a content, a user profile, user's terminal device ID, user's use status, a content use status and a content service providing status.

24. The terminal device according to claim 8,
wherein the terminal device includes:
a receiving unit operable to receive the indication information and a license; and
a content use unit operable to use a content according to the received license.

25. A history log collecting method for collecting history logs of a content in a system comprising a server device that provides the content and a terminal device that uses the content provided from the server device, the history log collecting method including:
a first acquirement step in which the terminal device acquires first history logs concerning the content use;
a second acquirement step in which the terminal device acquires second history logs concerning the content use;
a history log sending step in which the terminal device sends the first history logs and the second history logs separately;
a first collection step in which the server device collects the first history logs concerning the content use sent from the terminal device;
a second collection step in which the server device separately collects the first history logs and the second history logs concerning the content use sent from the terminal device; and
a verification step in which the server device verifies the collected first history logs and the collected second history logs.

26. A content history log collecting method executed in a server device that provides a terminal device that uses a content with a content, comprising:
a first collecting step of collecting first history logs concerning the content use sent from the terminal device;
a second collecting step of separately collecting the first history logs and second history logs concerning the content use sent from the terminal device; and
a verifying step of verifying the first history logs collected by the first collecting unit and the second history logs collected by the second collecting unit.

27. A history log collecting method for collecting content history logs in a terminal device that uses a content provided from a server, comprising:
a first acquirement step of acquiring first history logs concerning the content use;
a second acquirement step of acquiring second history logs concerning the content use; and
a history log sending step of separately sending the first history logs and the second history logs.

28. A program for causing a computer to execute the following steps so as to collect content history logs in a server device that provides the content for a terminal device that uses the content, the program comprising:
a first collecting step of collecting first history logs concerning the content use sent from the terminal device;
a second collecting step of separately collecting the first history logs and second history logs concerning the content use sent from the terminal device; and
a verifying step of verifying the first history logs collected by the first collecting unit and the second history logs collected by the second collecting unit.

29. A program for causing a computer to execute the following steps so as to collect content history logs in a terminal device that uses a content, the program comprising:
a first acquirement step of acquiring first history logs concerning the content use;
a second acquirement step of acquiring second history logs concerning the content use; and
a history log sending step of separately sending the first history logs and the second history logs.
